(19) United States
(12) Patent Application Publication
(10) Pub. No.: US 2025/0056599 A1
(43) Pub. Date: Feb. 13, 2025

(54) SYSTEMS AND METHODS FOR LAYER 3 SCHEDULING IN CELL-FREE NETWORKS

(71) Applicant: APPLE INC., Cupertino, CA (US)

(72) Inventors: Ahmed Gamal Helmy Mohamed, Cupertino, CA (US); Danila Zaev, Munich (DE); Ayman F. Naguib, Cupertino, CA (US)

(21) Appl. No.: 18/799,388

(22) Filed: Aug. 9, 2024

Related U.S. Application Data
(60) Provisional application No. 63/518,649, filed on Aug. 10, 2023.

(51) Int. Cl. H04W 74/04; H04W 74/00; H04W 74/08

(52) U.S. Cl. CPC H04W 74/04; H04W 74/002; H04W 74/0891

(57) ABSTRACT

Systems and methods for Layer 3 (L3) scheduling in cell-free networks are disclosed herein. A clustering control function (CCF) of a wireless communication system may operate with respect to a cluster of base stations that is used to communicate traffic with a user equipment (UE) on a radio bearer and that is divided into a plurality of sub-clusters. An L3 scheduler operated at/by the CCF may make an L3 scheduling determination that identifies a traffic-receiving sub-cluster from the plurality of sub-clusters and an active base station (a-BS) in the traffic-receiving sub-cluster and sending, to the cluster of base stations, the L3 scheduling determination. Uses for this information by the various applicable network elements within the cluster (the base stations and the UE) are described. Various mechanisms for the distribution of this information to the applicable network elements are described.

### TECHNICAL FIELD

This application relates generally to wireless communication systems, including for Layer 3 design in cell-free networks.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a diagram for an example of clustering in a cell-free network architecture, according to embodiments discussed herein.

FIG. 2 illustrates a diagram showing aspects of radio protocol use in cell-free network mechanisms, according to embodiments discussed herein.

FIG. 3A illustrates a diagram of an example L3 scheduling (e.g., that is used during the applicable TTI(s)) for an example network topology of a cell-free network.

FIG. 3B illustrates a radio protocol stack corresponding to the network topology illustrated in FIG. 3A.

FIG. 4 illustrates an example timeline for the use of an L3 scheduling agreement protocol, according to embodiments discussed herein.

FIG. 5A and FIG. 5B together illustrate an example timeline for the use of a latency-constrained L3 scheduling agreement protocol, according to embodiments discussed herein.

FIG. 6A and FIG. 6B together illustrate an example timeline for the use of a reliability-constrained L3 scheduling agreement protocol, according to embodiments discussed herein.

FIG. 7 illustrates a method of a CCF of a wireless communication system for performing L3 scheduling for a cluster of base stations used to communicate traffic with a UE on a radio bearer and that is divided into a plurality of sub-clusters, according to embodiments discussed herein.

FIG. 8 illustrates a method of a base station of a wireless communication system that is in a first sub-cluster of a cluster of base stations used communicate traffic with a UE on a radio bearer, according to embodiments discussed herein.

FIG. 9 illustrates a method of a UE for operating with a first base station of a wireless communication system that is in a first sub-cluster of a cluster of base stations used communicate traffic with the UE on a radio bearer, according to embodiments discussed herein.

FIG. 10 illustrates an example architecture of a wireless communication system, according to embodiments disclosed herein.

FIG. 11 illustrates a system for performing signaling between a wireless device and a network device as supported by a CN device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

### Clustering in Cell-Free Networks

In some wireless communication systems, a cell-free network architecture provides an adaptive/dynamic and UE-centric distribution of functionalities that may be associated with a “serving cell” as understood in the context of prior cell-based network architectures (e.g., such as an NR network architecture or an LTE network architecture). With respect to the present disclosure, it may be understood generally that a “cluster” or “serving cluster” of a UE is a set of physically and/or logically connected base stations over which functionalities related to the serving of the UE (e.g., traditional serving cell functionalities used in cell-based network architectures) may be distributed. Accordingly, (the concept of) a cluster may, under some perspectives, “replace” (the concept of) a serving cell of a UE as understood for prior cell-based networks.

A cluster may have a one-to-one mapping with a UE. Thus, separate (logical) clusters for each of two UEs may be understood/cognizable (even when each of the two corresponding clusters is made up of the same physical set of base stations). Further, note that a single base station may simultaneously belong to multiple clusters that each serve different UEs.

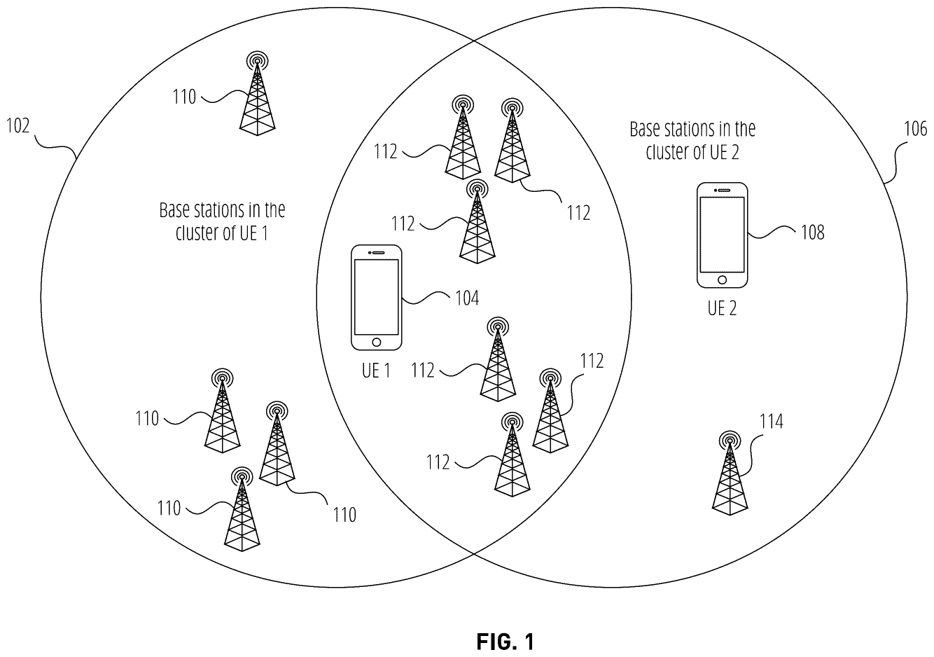

FIG. 1 illustrates a diagram for an example of clustering in a cell-free network architecture. A first cluster 102 of base stations serves a first UE 104 and a second cluster 106 of base stations serves the second UE 108. As illustrated, the first cluster 102 includes the first base stations 110 and the second base stations 112, while the second cluster 106 includes the second base stations 112 and the third base station 114.

Base stations in a same cluster are not necessarily required to jointly transmit/receive to/from the UE being served. Further, control plane and/or user plane functionalities may be dynamically distributed among the base stations in the cluster.

A clustering control function (CCF) may be defined as one or more logical function sets for the establishment and control of clusters in the wireless communication system. The CCF may be a distributed entity of the wireless communication system. For example, the CCF may be distributed across one or more of the core network, a RAN intelligent controller (RIC), and/or one or more base station(s) of the RAN.

The CCF may dynamically develop, update, control, and schedule UE-centric connected sets of clusters in certain geographical areas based on, for example: traffic, latency, reliability, coverage, interference, sensing, mobility, cell load, radio resource management (RRM) aspects, radio link quality, backhaul ideality, location, quality of service (QOS) requirements, and/or measurement reports, etc.

In some wireless communication systems, clustering in cell-free networks includes concepts such as a UE-centric cluster, a CCF, connected base stations (cBSs) (e.g., base stations that are part of a cluster serving a UE), neighboring un-connected base stations (uBSs) (e.g., neighboring base stations to a UE that are not currently part of a cluster serving the UE), etc. In some such systems, a CCF includes functionalities, protocols, message exchange capabilities, and the like that may be used for cluster establishment and/or update tasks (among other things). UEs and base stations may include corresponding functionalities, protocols, message exchange capabilities, and the like supporting the use of clustering as described herein.

In wireless communication systems implementing cell-free networks, it may be that cell-free radio resource control (RRC) connection establishment and maintenance messaging protocols are used. This may mean, among other things, that an RRC state of a UE is understood with respect to the network generally (rather than with respect to a particular serving cell).

Further, such wireless communication systems for cell-free networks may use one or more cluster establishment options corresponding to an initial access of the UE and/or to cluster updating mechanisms (e.g., that control the composition of base stations in the cluster after the UE's initial access). These may include, for example, “greedy”, downlink (DL)-based, uplink (UL)-based, and/or real-time methodologies (and any corresponding message exchanges).

### Radio Protocol in Cell-Free Networks

In some wireless communication systems, “cluster partitioning” represents a radio-bearer-specific dynamic partition of a cluster serving a UE into logical sub-clusters. Such a cluster partitioning into sub-clusters may be determinative of a protocol stack architecture that applies with respect to that cluster. For example, sub-clusters according to the partitioning may be in one-to-one correspondence with radio link control (RLC) entities. Base stations in a same sub-cluster may then, for example, each carry a copy of the same logical RLC entity for a given radio bearer.

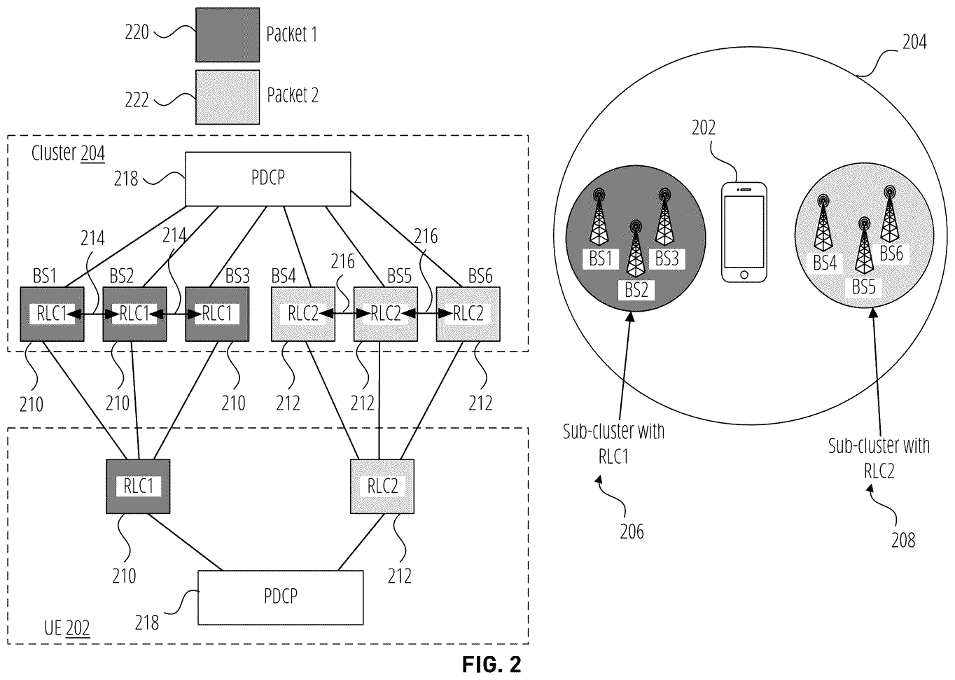

FIG. 2 illustrates a diagram showing aspects of radio protocol use in cell-free network mechanisms, according to embodiments discussed herein. A UE 202 is served by a cluster 204. Within the cluster 204, there is a first sub-cluster 206 that corresponds to a first RLC entity 210 used between the UE 202 and the cluster 204 and a second sub-cluster 208 that corresponds to a second RLC entity 212 between the UE 202 and the cluster 204. The first RLC entity 210 and the second RLC entity 212 are RLC entities used by a packet data convergence protocol (PDCP) entity 218 that corresponds to a radio bearer between the UE 202 and the cluster 204 and that uses the illustrated cluster partitioning.

As illustrated, the first RLC entity 210 is synchronized 214 across the base stations of the first sub-cluster 206 (BS1, BS2, and BS3). This means that, for example, each of these base stations has and operates according to a copy of the first RLC entity 210, as shown. Further, the second RLC entity 212 is synchronized 216 across the base stations of the second sub-cluster 208 (BS4, BS5, and BS6). This means that, for example, each of these base stations has and operates according to a copy of the second RLC entity 212, as shown. Note that, as illustrated, the arrangement of particular base stations of the cluster into the first sub-cluster 206 or second sub-cluster 208 may be transparent to the UE (the UE knows about/operates in terms of the first RLC entity 210 and the second RLC entity 212 (in terms of the sub-clusters), without consideration with respect to particular base stations underlying those RLC entities/sub-clusters).

In the illustrated case, a first packet 220 of the radio bearer corresponding to the PDCP entity 218 is handled at the first RLC entity 210. This ultimately means that the first packet 220 is communicated between the UE 202 and the cluster 204 via one or more of the base stations of the first sub-cluster 206. Further, a second packet 222 of the (same) radio bearer corresponding to the PDCP entity 218 is handled at the second RLC entity 212. This ultimately means that the second packet 222 is communicated between the UE 202 and the cluster 204 via one or more of the base stations of the second sub-cluster 208.

It is contemplated that a cluster partitioning may be updated over time. Establishment and/or updating of a cluster partitioning may take into account QoS requirements and traffic properties associated with a radio bearer. For example, latency constraints and/or traffic periodicity may be considered. These mechanisms allow the network (e.g., a CCF) to optimally configure sub-cluster-enabled multi-connectivity of a UE to a cluster in, for example, a non-ideal backhaul scenario (where different partitionings of a same cluster may have appreciably different QoS/traffic management characteristics). Cluster partitioning may be used as a way to connect dynamic traffic QoS requirements with adaptive multi-connectivity mode selection and/or a layer 2 protocol structure.

In some wireless communication systems, radio protocols in cell-free networks utilize concepts such as cluster partitioning/sub-clusters, RLC synchronization, etc. A functionality for control over dynamically updating cluster partitions, and a corresponding protocol for the update procedure, may be used. PDCP data routing options and a corresponding configuration may be used. Finally, a cell-free radio bearer configuration and/or a message exchange procedure for radio bearer establishment may be used.

### L3 Scheduling in Cell-Free Networks

Various wireless communication systems may use a cluster (a set of base stations over which “serving cell” functionality as understood in prior cell-based systems is instead dynamically distributed) that is understood in terms of a cluster partitioning into sub-cluster(s) that provide a mechanism to connect dynamic traffic QoS requirements with adaptive multi-connectivity mode selection and a layer 2 protocol structure.

Within the context of such wireless systems, various layer 3 (L3) design options for the support of cell-free specific and dynamic characteristics may be considered. Embodiments disclosed herein may accordingly relate to definitions for L3 scheduling procedures and/or L3 schedulers that dynamically form and update logical states of (bearer-specific) sub-clusters and/or base station(s) upon request and/or based on QoS requirements and measurement reports. Embodiments disclosed herein may relate to definitions for logical states of traffic receiving sub-clusters, active base stations (a-BSs), and inactive base stations (i-BSs), and corresponding operations, requirements, and specifications. Embodiments disclosed herein may relate to definitions for L3 schedulers, base stations, and UEs that support L3 scheduling procedures as discussed herein. Embodiments disclosed herein may relate to proposals for L3 scheduling agreement protocols (for example, concepts, parameters, modes, and/or messaging exchanges that may be used attendant to such L3 scheduling agreement protocols).

Various concepts discussed herein as related to L3 scheduling in a cell-free network may include, for example, dynamic UE-centric clustering mechanisms that replace cell-based L3 procedures (e.g., the cell-based concept of handover may be replaced), cell-free RRC aspects, cell-free schedulers for both shared and control channels, and/or the use of a virtualized PDCP.

Embodiments discussed herein relate to L3 scheduling procedures. An L3 scheduling procedure in a cell-free network may be conceived as a logical L3 procedure which may dynamically (for example, at a transmit time interval (TTI) granularity), form, update, and/or schedule (bearer-specific) sub-clusters and base station logical states into connected sets of traffic receiving sub-clusters, a-BSs, and/or i-BSs. Such L3 scheduling may occur upon request, or it may occur based on QoS requirements and measurement reports.

Connected set information may include information on which set of sub-clusters and base stations may (or may not) be scheduled to handle traffic between the UE and the cluster (in uplink (UL) and/or downlink (DL)) for a given radio bearer (e.g., during applicable TTI(s)).

In some embodiments, an L3 scheduling procedure may be performed by an L3 scheduler. This L3 scheduler may be logical L3 module set in the network. In various cases, the L3 scheduler exists within/as part of the CCF for the applicable cluster.

In some embodiments, a sub-cluster corresponding to a radio bearer may have a logical state of “traffic-receiving sub-cluster” during applicable TTI(s). For example, for the applicable radio bearer, an L3 scheduler may understand one or more sub-clusters of the radio bearer as traffic-receiving sub-clusters. These traffic-receiving sub-clusters then accordingly handle traffic of the radio bearer between the UE and the cluster (in UL and/or DL) during the applicable TTI(s).

In some embodiments, a base station may have a logical state of “a-BS” during applicable TTI(s). For example, for an applicable radio bearer, an L3 scheduler may understand one or more base stations of the cluster as a-BS(s). These a-BS(s) then accordingly handle traffic of the radio bearer between the UE and the cluster (in UL and/or DL) during the applicable TTI(s). The logical state of a-BS for a base station may be understood to indicate that the medium access control (MAC) layer of that base station is used to actively allocate resources used for the transport of data through the base station (in UL and/or DL).

In some embodiments, a base station may have a logical state of “i-BS” during applicable TTI(s). For example, for an applicable radio bearer, an L3 scheduler may understand one or more base stations of the cluster as i-BS(s). These i-BS(s) are not used to handle traffic of the radio bearer between the UE and the cluster during the applicable TTI(s). The logical state of i-BS for a base station may be understood to indicate that the medium access control (MAC) layer of that base station is not used to actively allocate resources used for the transport of data through the base station (in either UL or DL).

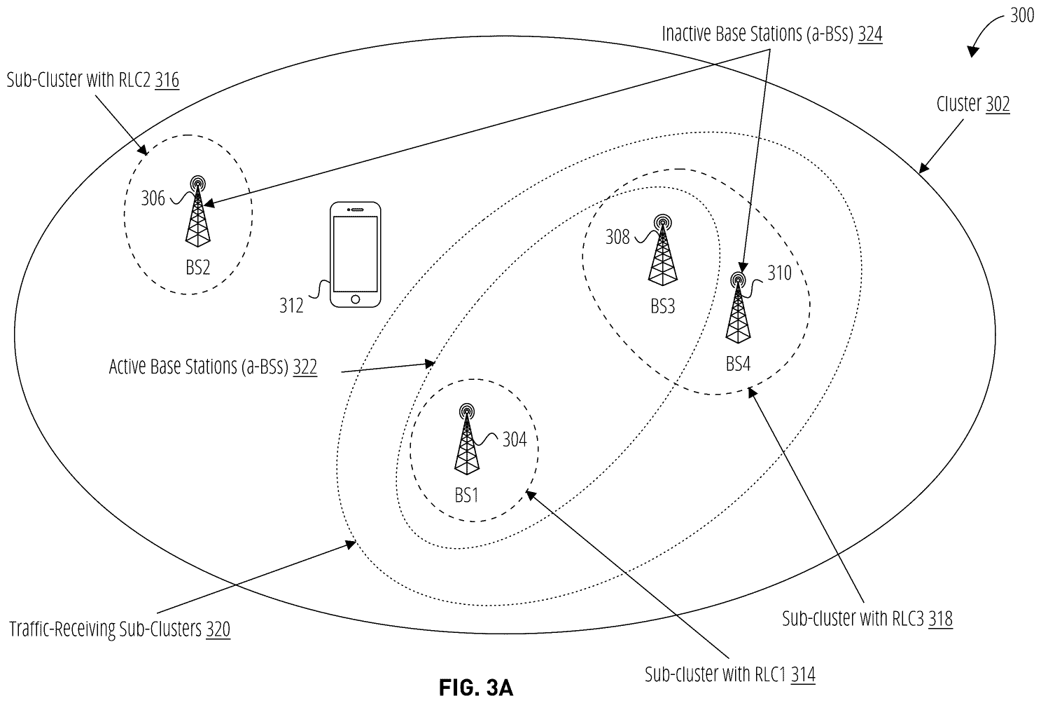

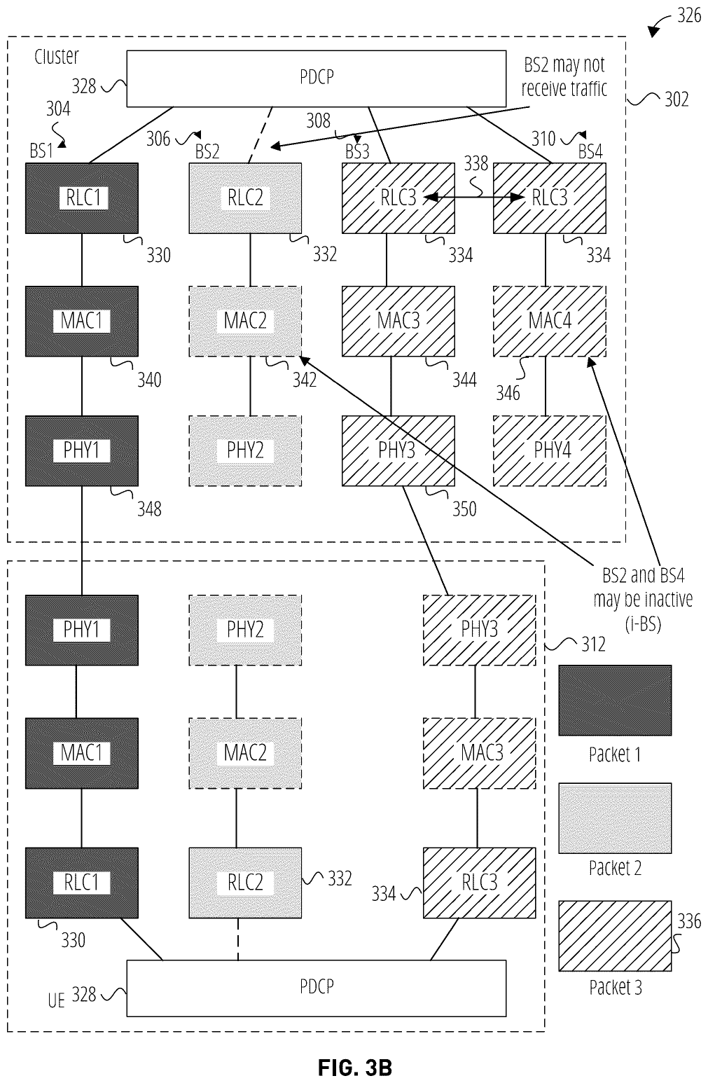

FIG. 3A and FIG. 3B relate to a cluster partitioning for a radio bearer used between a cluster 302 and a UE 312 during applicable TTI(s). FIG. 3A illustrates a diagram 300 of an example L3 scheduling (e.g., that is used during the applicable TTI(s)) for an example network topology of a cell-free network. FIG. 3B illustrates a radio protocol stack 326 corresponding to the network topology illustrated in FIG. 3A.

The cluster 302 of base stations (which includes a first base station 304 (BS1), a second base station 306 (BS2), a third base station 308 (BS3), and the fourth base station 310 (BS4)) serves the UE 312. As illustrated, according to the cluster partitioning in use, there is a first sub-cluster 314 in a one-to-one correspondence with a first RLC entity 330 (RLC1) and made up of the first base station 304, a second sub-cluster 316 in a one-to-one correspondence with a second RLC entity 332 (RLC2) and made up of the second base station 306, and a third sub-cluster 318 in a one-to-one correspondence with a third RLC entity 334 (RLC3) and made up of the third base station 308 and the fourth base station 310.

FIG. 3A illustrates one possible result of an L3 scheduling procedure performed by an L3 scheduler given the provided cluster partitioning. Preliminarily, it is observed that the L3 scheduler has identified the first sub-cluster 314 having the first base station 304 and the third sub-cluster 318 having the third base station 308 and the fourth base station 310 as traffic-receiving sub-clusters 320.

FIG. 3A illustrates further illustrates possible states for base stations of the cluster in the illustrated circumstances. For example, each of the first base station 304 of the first sub-cluster 314 and the third base station 308 of the third sub-cluster 318 are identified by the L3 scheduler as a-BSs 322. Note that the fourth base station 310 of the third sub-cluster 318 is otherwise identified by the L3 scheduler as one of the set of i-BSs 324 (illustrating that a base station may be identified an i-BS even when it is within a traffic-receiving sub-cluster). Also note that as the second sub-cluster 316 having the second base station 306 is not identified in the set of traffic-receiving sub-clusters 320, the second base station 306 that makes up the second sub-cluster 316 is also understood as one of the set of i-BSs 324.

Within the radio protocol stack 326 for this arrangement, there is a PDCP entity 328 corresponding to the radio bearer. Beneath the PDCP entity 328, there is the first RLC entity 330 corresponding to the first sub-cluster 314 having the first base station 304, the second RLC entity 332 corresponding to the second sub-cluster 316 having the second base station 306, and the third RLC entity 334 corresponding to the third sub-cluster 318 made up of the third base station 308 and the fourth base station 310.

As illustrated in FIG. 3B, the third base station 308 and the fourth base station 310 of the third sub-cluster 318 are synchronized 338 with respect to the third RLC entity 334, meaning that the RLC entity instances as understood at each of the third base station 308 and the fourth base station 310 are identical instances of the third RLC entity 334 and/or that each of the third base station 308 and the fourth base station 310 use the same (single, shared) instance of the third RLC entity 334 for traffic routing. Note that, as illustrated, no matter the situation with the third RLC entity 334 at the cluster 302, the UE 312 uses/understands a single third RLC entity 334 (any reproduction and/or sharing of the third RLC entity 334 as between the third base station 308 and the fourth base station 310 at the cluster 302 is transparent to the UE 312).

A PDCP entity may be assumed to route the same data traffic of the data bearer to all synchronized RLC entities at the network side. For example, as illustrated in FIG. 3B, the same packet 336 is routed to each copy of the third RLC entity 334 used in the cluster 302 at each of the third base station 308 and/or the fourth base station 310.

On the other hand, base stations of different sub-clusters for the same PDCP entity do not use (or at least do not require the use of) synchronized RLC entities. The PDCP entity may accordingly not be required and/or necessarily expected to route the same data traffic across non-synchronized RLC entities.

In relation back to the L3 scheduling illustrated in FIG. 3A, it may be the case that the PDCP entity 328 routes traffic (packets) to each of first RLC entity 330 and the third RLC entity 334, as these RLC entities correspond to the first sub-cluster 314 and the third sub-cluster 318, which are traffic-receiving sub-clusters 320. On the other hand, the PDCP entity 328 may not route traffic to the second RLC entity 332, as the second RLC entity 332 corresponds to the second sub-cluster 316 which is not a traffic-receiving sub-cluster 320.

FIG. 3B further illustrates that because the first base station 304 and the third base station 308 are a-BSs, a MAC entity for each (the first MAC entity 340 for the first base station 304 and the third MAC entity 344 for the third base station 308) allocates physical (PHY) layer resources for use to actively transport data through the radio protocol stack 326 (at the first PHY entity 348 for the first base station 304 and at the third PHY entity 350 for the third base station 308).

On the other hand, because each of the second base station 306 and the fourth base station 310 are i-BSs, MAC entities for each (the second MAC entity 342 for the second base station 306 and the fourth MAC entity 346 for the fourth base station 310) do not allocate PHY resources for active data transport. Note that this is the case with respect to fourth base station 310 even though it is in one of the traffic-receiving sub-clusters 320.

It should be understood that a-BS or i-BS state as used by a base station may be a radio bearer-specific state of the base station. In other words, a base station that is an a-BS or an i-BS with respect to a first radio bearer for a first UE served by a first (logical) cluster may simultaneously and independently be an a-BS or an i-BS with respect to a second radio bearer served to the first UE by the first cluster and/or to a third radio bearer served to a second UE by a second (logical) cluster (for that second UE) to which the base station also belongs.

Various aspects of possible statuses under a cluster partitioning outcome for an applicable radio bearer (e.g., as defined by QoS requirements) that is used within a defined UE-specific cluster and at applicable TTI(s) are now discussed.

With respect to traffic-receiving sub-clusters: in some embodiments, a PDCP entity for the radio bearer routes traffic to (e.g., only) RLC entity(s) that correspond to the base station(s) which belong to a connected set of traffic receiving sub-clusters for that radio bearer within the UE-specific cluster (regardless of any logical state of a-BS or i-BS for the base station(s)). Further, the PDCP entity does not route traffic to any RLC entities that do not correspond to any base station(s) which belong to the connected set of traffic-receiving sub-clusters. Note that for the base station(s) which belong to the connected set of traffic-receiving sub-clusters, the PDCP entity may adopt either a PDCP Duplicated Packet data routing mode (where all base stations transport copies of the same traffic) and/or PDCP Distinguished Packet data routing mode (where each base station transports unique (or at least independent) traffic).

With respect to a-BSs: RLC entity(s) that correspond to base station(s) which belong to a connected set of a-BS(s) within the traffic receiving sub-cluster(s) may receive routed traffic from the PDCP entity. Further, any MAC and PHY entities that correspond to these a-BS(s) may allocate resources for the UE.

With respect to i-BSs: RLC entity(s) that correspond to base station(s) which belong to a connected set of i-BS(s) (each of which may or may not be within the connected set of traffic-receiving sub-cluster(s)), may or may not receive routed traffic from the PDCP entity. Whether such traffic is received at the RLC entity corresponding to the i-BS depends on whether or not the i-BS is located within a traffic-receiving sub-cluster. If so, the traffic is sent to the RLC entity for purposes of use by an a-BS of that sub-cluster; if not, the traffic is not sent to the RLC entity. Further, it may be assumed that MAC and PHY entities that correspond to these i-BS(s) may not allocate resources for the UE.

Various aspects related to the use of an L3 scheduler under a cluster partitioning outcome for an applicable radio bearer (e.g., as defined by QoS requirements) that is used within a defined UE-specific cluster and at applicable TTI(s) are now discussed.

In various embodiments, the L3 scheduler may dynamically request a UE and/or base station(s) to share information and measurements about mobility, environment, interference, and QoS requirements.

In various embodiments, the L3 scheduler may dynamically form connected sets of traffic-receiving sub-clusters, a-BSs, and/or i-BSs within the cluster.

In various embodiments, the L3 scheduler may dynamically update the connected sets of traffic receiving sub-cluster(s), a-BS(s), and/or i-BS(s) within a UE-specific cluster by modifying, adding, or removing sub-cluster(s), a-BS(s), and/or i-BS(s) within/to/from those connected sets.

In various embodiments, the L3 scheduler may dynamically configure any associated PDCP, RLC, MAC, and/or PHY entities that correspond to the connected sets of traffic receiving sub-cluster(s), a-BS(s), and/or i-BS(s).

In various embodiments, the L3 scheduler may dynamically validate RLC synchronization requirements and/or configurations that correspond to connected sets of traffic receiving sub-cluster(s), a-BS(s), and/or i-BS(s).

In various embodiments, the L3 scheduler may dynamically communicate and announce any updated connected sets of traffic receiving sub-cluster(s), a-BS(s), and/or i-BS(s) and their associated PDCP, RLC, MAC, and PHY entities configurations to corresponding network elements via the appropriate interface.

In various embodiments, the L3 scheduler may dynamically request that any base station within a UE-specific cluster be (e.g., possibly) added/removed to/from one or more of the connected sets of traffic receiving sub-cluster(s), a-BS(s), and/or i-BS(s).

In various embodiments, the L3 scheduler may dynamically accept or reject any requests from a UE and/or a base station for addition/removal of a base station to/from one or more of the connected sets of traffic receiving sub-cluster(s), a-BS(s), and/or i-BS(s).

In various embodiments, the L3 scheduler may dynamically request a base station and/or a UE to re-initiate previously-rejected base station addition/removal requests to/from one or more of the connected sets of traffic receiving sub-cluster(s), a-BS(s), and/or i-BS(s);

In various embodiments, the L3 scheduler may dynamically determine and announce time validity requirements to the UE and/or the base station(s) of the cluster (regardless of their logical state) at which information corresponding to an L3 scheduler decisions (including associated PDCP, RLC, MAC, and PHY entities configurations) are considered valid.

In various embodiments, the L3 scheduler may dynamically determine and announce time advance requirements to allow a UE and the base station(s) of the cluster (regardless of their logical state) to configure any associated PDCP, RLC, MAC, and PHY entities.

In various embodiments, the L3 scheduler may dynamically form and/or update the connected sets of traffic receiving sub-cluster(s), a-BS(s), and/or i-BS(s) based on any one or more of a variety of possible triggers. In some cases, the formation and/or updating of the connected sets of traffic receiving sub-cluster(s), a-BS(s), and/or i-BS(s) is based on feedback from a UE and/or updated information with respect to mobility, measurement reports, and/or traffic/QoS requirements. In some cases, the formation and/or updating of the connected sets of traffic receiving sub-cluster(s), a-BS(s), and/or i-BS(s) is based on RLC synchronization changes reported by any of the base station(s) within any of the connected sets of traffic receiving sub-cluster(s), a-BS(s), and/or i-BS(s). In some cases, the formation and/or updating of the connected sets of traffic receiving sub-cluster(s), a-BS(s), and/or i-BS(s) is based on a UE request/proposal for base station addition/removal to/from any of the connected sets of traffic receiving sub-cluster(s), a-BS(s), and/or i-BS(s). In some cases, the formation and/or updating of the connected sets of traffic receiving sub-cluster(s), a-BS(s), and/or i-BS(s) is based on a UE acceptance/rejection of base station addition/removal to/from any of the connected sets of traffic receiving sub-cluster(s), a-BS(s), and/or i-BS(s). In some cases, the formation and/or updating of the connected sets of traffic receiving sub-cluster(s), a-BS(s), and/or i-BS(s) is based on a base station request/proposal for base station addition/removal to/from any of the connected sets of traffic receiving sub-cluster(s), a-BS(s), and/or i-BS(s). In some cases, the formation and/or updating of the connected sets of traffic receiving sub-cluster(s), a-BS(s), and/or i-BS(s) is based on a base station acceptance/rejection of base station addition/removal to/from any of the connected sets of traffic receiving sub-cluster(s), a-BS(s), and/or i-BS(s). It is further contemplated that any combination and/or subset of these reasons may trigger the L3 scheduler to dynamically form and/or update the connected sets of traffic receiving sub-cluster(s), a-BS(s), and/or i-BS(s).

Various base station aspects related to the use of an L3 scheduler under a cluster partitioning outcome for an applicable radio bearer (e.g., as defined by QoS requirements) that is used within a defined UE-specific cluster and at applicable TTI(s) are now discussed. The base stations under discussion may belong to any of the connected sets of traffic receiving sub-cluster(s), a-BS(s), and/or i-BS(s).

In various embodiments, a base station can request a UE to share information and/or measurements about mobility, environment, interference, and QoS requirements.

In various embodiments, a base station can request a UE to share its current capabilities (for example, central processing unit (CPU) loads, memory usage, and/or supported bands, etc.).

In various embodiments, a base station can send the L3 scheduler a request for base station addition/removal of one or more base station(s) to/from one or more of the connected sets of traffic receiving sub-cluster(s), a-BS(s), and/or i-BS(s).

In various embodiments, a base station can accept or reject any L3 scheduler addition/removal decision/request for one or more base station(s) to/from any of the connected sets of the connected sets of traffic receiving sub-cluster(s), a-BS(s), and/or i-BS(s).

In various embodiments, a base station can request the L3 scheduler to re-initiate a previously-rejected addition/removal decision for one or more base station(s) to/from one or more of the connected sets of the connected sets of traffic receiving sub-cluster(s), a-BS(s), and/or i-BS(s).

In various embodiments, a base station can communicate any L3 scheduler addition/removal decision for one or more base station(s) to/from any of the connected sets of traffic receiving sub-cluster(s), a-BS(s), and/or i-BS(s) to a UE via proper interface;

In various embodiments, a base station can configure its associated PDCP, RLC, MAC, and PHY entities that correspond to the connected sets of traffic receiving sub-cluster(s), a-BS(s), and/or i-BS(s) based on any (e.g, accepted) L3 scheduler decision(s).

In various embodiments, a base station can allocate, release, and/or update resources for its MAC and PHY entities that correspond to the connected sets of traffic receiving sub-cluster(s), a-BS(s), and/or i-BS(s) based on time advance information and/or any (e.g., accepted) L3 scheduler decision(s).

Note that it is expressly contemplated that any combination and/or subset of these functions may be used.

Various UE aspects related to the use of an L3 scheduler under a cluster partitioning outcome for an applicable radio bearer (e.g., as defined by QoS requirements) that is used within a defined UE-specific cluster and at applicable TTI(s) are now discussed. Note that corresponding to these aspects, the internal structure of any sub-cluster may be transparent to the UE (as discussed elsewhere herein).

In various embodiments, a UE can send the L3 scheduler a request for sub-cluster(s) addition/removal of one or more sub-cluster(s) to/from the connected set of traffic-receiving sub-clusters.

In various embodiments, a UE can accept or reject any L3 scheduler addition/removal decisions/requests for one or more sub-cluster(s) to/from the connected set of traffic-receiving sub-clusters;

In various embodiments, a UE can send the L3 scheduler a request to re-initiate previously rejected sub-cluster addition/removal decisions for one or more sub-cluster(s) to/from the connected set of traffic-receiving sub-clusters;

In various embodiments, a UE can accept or reject a network request to the UE to provide information, current capabilities, and/or measurements reports.

In various embodiments, a UE can configure its associated PDCP, RLC, MAC, and PHY entities that correspond to the connected set of traffic-receiving sub-clusters based on the (e.g., accepted) L3 scheduler decisions.

In various embodiments, a UE can allocate, release, and/or update resources for its MAC and PHY entities based on time advance information and/or (e.g., accepted) L3 scheduler decisions.

Note that it is expressly contemplated that any combination and/or subset of these functions may be used.

In some embodiments, it may be that a UE does not intervene in L3 scheduler decisions related to the connected sets of a-BS(s) and/or i-BS(s).

### Embodiments of L3 Scheduling Agreement Protocols

In some embodiments, an L3 scheduling agreement protocol may be provided as a logical L3 procedure that is part of an L3 scheduling protocol used by an L3 scheduler. An L3 scheduling agreement protocol may be used by the L3 scheduler to communicate and announce any formation of and/or update to the connected sets of traffic receiving sub-cluster(s), a-BS(s), and/or i-BS(s) (and any associated PDCP, RLC, MAC, and PHY entity configurations) to affected network elements (the UE and any base station(s) within a UE-specific cluster). Note that such communication may occur via any appropriate interface between the L3 scheduler and the network element.

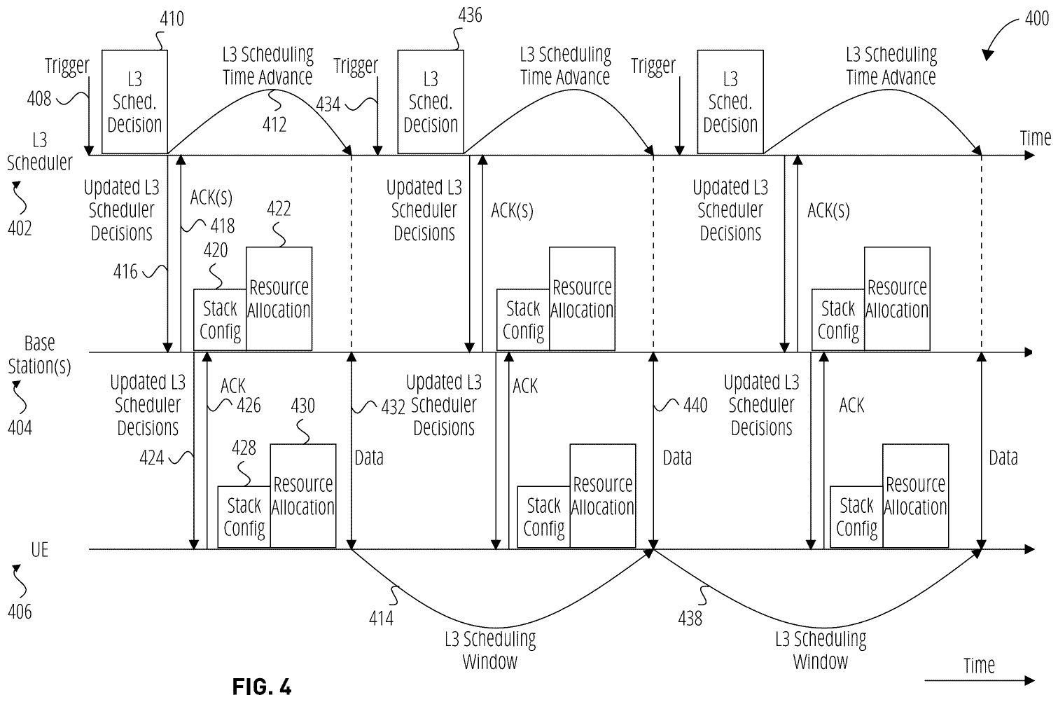

FIG. 4 illustrates an example timeline 400 for the use of an L3 scheduling agreement protocol, according to embodiments discussed herein. The timeline 400 illustrates functionalities of and communications between an L3 scheduler 402, one or more base station(s) 404, and a UE 406. The base station(s) 404 may be the base stations that make up the cluster for the UE 406. The L3 scheduler 402 may exist within/as part of a CCF for this cluster.

It may be understood that the timeline 400 corresponds to the use of an existing cluster partitioning of the cluster for a first radio bearer that is used to transport traffic between the cluster and the UE.

As illustrated, a first trigger 408 occurs, causing the L3 scheduler 402 to take a first L3 scheduling decision 410. The first trigger 408 may be any trigger for forming and/or updating connected sets of traffic receiving sub-cluster(s), a-BS(s), and/or i-BS(s). The first L3 scheduling decision 410 may accordingly correspond to a determined formation of and/or update to the connected sets of traffic receiving sub-cluster(s), a-BS(s), and/or i-BS(s) (and any associated PDCP, RLC, MAC, and PHY entity configurations at the base station(s) 404 and/or the UE 406).

Within a wireless communication system, it may be understood that an L3 scheduling decision applies at a later time than, e.g., a TTI during which the L3 scheduling decision is taken by the L3 scheduler. The time period between the L3 scheduling decision and its application may be referred to as an L3 scheduling time advance. An L3 scheduling time advance may be as defined with respect to one or more applicable time advance requirements (e.g., as defined by a requirement that an L3 scheduling decision is taken x TTIs in advance of its applicability, as determined by an implementation of the wireless communication system and/or other requirements). An L3 scheduling time advance may allow the UE and the any base station(s) of the UE-specific cluster (regardless of their logical state) time prior to the application of the L3 scheduling decision to configure any associated PDCP, RLC, MAC, and PHY entities for the applicable radio bearer accordingly.

An L3 scheduler may also identify an L3 scheduling window that is to be provided to other network entities. For example, the L3 scheduler may declare and announce an L3 scheduling window, during which an L3 scheduling decision taken by the L3 scheduler with respect to the connected sets of traffic receiving sub-cluster(s), a-BS(s), and/or i-BS(s) (and any associated PDCP, RLC, MAC, and PHY entity configurations for the base station(s) and/or the UE) should be considered valid. The L3 scheduling window may begin at the end of a corresponding L3 scheduling time advance for the corresponding L3 scheduling decision.

Accordingly, as illustrated in FIG. 4, corresponding to the first L3 scheduling decision 410, a first L3 scheduling time advance 412 is determined by the L3 scheduler 402. The L3 scheduler then identifies the corresponding first L3 scheduling window 414 having a beginning that is controlled by the end of the first L3 scheduling time advance 412, as shown.

After the first L3 scheduling decision 410 is taken, the L3 scheduler 402 sends 416 information corresponding to the first L3 scheduling decision 410 to the base station(s) 404. This information may include information about formation of and/or updates to the connected sets of traffic receiving sub-cluster(s), a-BS(s), and/or i-BS(s) (and any associated PDCP, RLC, MAC, and PHY entity configurations). This information may also include an identification of the first L3 scheduling window 414 (e.g., the beginning of the first L3 scheduling window 414) to the base station(s) 404. The base station(s) 404 may send 418 acknowledgment(s) (ACK(s)) to the L3 scheduler 402 in response. The base station(s) 404 then perform stack configuration 420 and resource allocation 422 according to the received information, as illustrated.

The base station(s) 404 then send 424 the information corresponding to the first L3 scheduling decision 410 (as described above) to the UE 406. The UE 406 may send 426 an ACK to the base station(s) 404 in response. The UE 406 then performs stack configuration 428 and resource allocation 430 according to the received information, as illustrated.

Then, once the timing of the first L3 scheduling window 414 is reached, the base station(s) 404 and the UE 406 perform first data communication 432 according to the first L3 scheduling decision 410.

As illustrated, during the first L3 scheduling window 414, a second trigger 434 may cause the L3 scheduler 402 to take a second L3 scheduling decision 436 (which may be different from the first L3 scheduling decision 410). The second L3 scheduling decision 436 results in information about formation of and/or updates to the connected sets of traffic receiving sub-cluster(s), a-BS(s), and/or i-BS(s) (and any associated PDCP, RLC, MAC, and PHY entity configurations) that apply to second data communication 440 and about a timing of a second L3 scheduling window 438 during which this information about the connected sets and any associated entity(s) applies. This information may be communicated to the base station(s) 404 and the UE 406 analogously to the manner previously described in relation to the information corresponding to first L3 scheduling decision 410 (as illustrated).

Note that the second trigger 434, the second L3 scheduling decision 436, and the associated communications of related information to the base station(s) 404 and the UE 406 occur while the first data communication 432 of during the first L3 scheduling window 414 and corresponding to information corresponding to the first L3 scheduling decision 410 is occurring.

The procedure as described may continue to repeat over time as new triggers occur, as illustrated in FIG. 4.

Various embodiments for an L3 scheduling agreement protocol used with respect to an applicable radio bearer (e.g., as defined by QoS requirements) are now discussed.

First embodiments for L3 scheduling agreement protocols relate to latency-constrained L3 scheduling agreement protocols. In a latency-constrained L3 scheduling agreement protocol, a single a-BS within a traffic-receiving sub-cluster may be selected by the L3 scheduler to communicate the information corresponding to L3 scheduler decisions about connected sets of traffic receiving sub-cluster(s), a-BS(s), and/or i-BS(s) (and any associated PDCP, RLC, MAC, and PHY entity configurations) to other network elements (UE and base station(s)) of the cluster. The communication from the selected a-BS to the other network elements may occur via extended messaging, using a corresponding interface. A latency-constrained L3 scheduling agreement protocol may be provided for use in latency-constrained cases.

The a-BS used in a latency-constrained L3 scheduling agreement protocol to communicate L3 scheduling information to the other network elements may be referred to as a “transporter base station.” For example, corresponding to an applicable TTI, the L3 scheduler may identify a base station as a transporter base station that is to be used to communicate information corresponding updated and upcoming L3 scheduling decisions about formation and/or update of the connected sets of traffic receiving sub-cluster(s), a-BS(s), and/or i-BS(s) (and any associated PDCP, RLC, MAC, and PHY entity configurations) to other corresponding network elements (the UE and any other base station(s)) of the cluster via extended messaging, using a corresponding interface. Note that corresponding to such cases, it may be that no level of base-station-to-base-station synchronization is required for the transporter base station transport this information.

Second embodiments for L3 scheduling agreement protocols relate to reliability-constrained L3 scheduling agreement protocols. In a reliability-constrained L3 scheduling agreement protocol, multiple active base stations (a-BSs), either within the same traffic receiving sub-cluster or not, may be selected by the L3 scheduler to communicate information corresponding to updated L3 scheduler decisions about connected sets of traffic receiving sub-cluster(s), a-BS(s), and/or i-BS(s) (and any associated PDCP, RLC, MAC, and PHY entity configurations) to other network elements (UE and base station(s)) of the cluster. This communication from these a-BSs to the other network elements may occur via jointly transmitted extended messaging, using a corresponding interface. The use of multiple a-BSs for such a joint transmission may result in relatively better transmission/reception quality than an analogous case where a single a-BS is used (e.g., as in a latency-constrained L3 scheduling agreement protocol). A reliability-constrained L3 scheduling agreement protocol may thus be provided for use in reliability-constrained cases. Note that corresponding to such cases, synchronization between the multiple a-BSs of the joint transmission may be utilized.

The a-BSs used in a reliability-constrained L3 scheduling agreement protocol to communicate L3 scheduling information to the other network elements may be referred to as a “transporter base station group.” For example, corresponding to an applicable TTI, the L3 scheduler may identify multiple base stations that are to be used to communicate information corresponding to updated and upcoming L3 scheduling decisions about formation and/or update of the connected sets of traffic receiving sub-cluster(s), a-BS(s), and/or i-BS(s) (and any associated PDCP, RLC, MAC, and PHY entity configurations) to the other corresponding network elements (UE and any other base station(s)) of the cluster via extended messaging, using a corresponding interface. Note that corresponding to such cases, a transporter base station group may or may not be made up of base stations from a single sub-cluster. Further, it may be that at least some level of base-station-to-base-station synchronization is utilized to facilitate the (e.g., joint) transport of this information.

Various details corresponding to the fit of, specifically, a latency-constrained L3 scheduling agreement protocol and/or a reliability-constrained L3 scheduling agreement protocol within the context of a general L3 scheduling agreement protocol (e.g., as described above in relation to FIG. 4) are now discussed.

In some embodiments, it may be that a reliability-constrained L3 scheduling agreement protocol adopts a relatively larger L3 scheduling window and/or a relatively larger L3 scheduling time advance as compared to a latency-constrained L3 scheduling agreement protocol.

In some embodiments, at an applicable TTI, base stations within a UE-specific cluster are able to exchange messages using, for example, an Xn interface. The L3 scheduler may form and/or update the connected sets of traffic receiving sub-cluster(s), a-BS(s), and/or i-BS(s) (and any associated PDCP, RLC, MAC, and PHY entity configurations). Information corresponding to the L3 scheduler's decisions in this regard may be communicated to the corresponding network elements (UE and base station(s)) of the cluster via either an identified transporter base station (e.g., in a latency-constrained L3 scheduling agreement protocol case) or a transporter BS group (e.g., in a reliability-constrained L3 scheduling agreement protocol case) during an L3 scheduling time advance.

Specific behaviors that may occur during the L3 scheduling time advance are now discussed.

In the case of a reliability-constrained L3 scheduling agreement protocol, the L3 scheduler may validate the PDCP, RLC, MAC, and PHY entity synchronization and configuration requirements for a transporter BS group in order to ensure proper reception of the L3 scheduler's decisions at at least an applicable reliability level.

Further, it may be assumed that the corresponding UE and base station(s) (whether a-BS(s) or i-BS(s)) may acknowledge and report back to the identified transporter base station or transporter base station group (as the case may be) any success/failure of the delivery of the updated L3 scheduler decision information.

It may be assumed that either an identified transporter base station or transporter base station group (as the case may be) may acknowledge and report back to the L3 scheduler any success/failure of the delivery of the updated L3 scheduler decision information.

If accepted, the UE and any base station(s) (regardless of their logical state) may follow the L3 scheduler decision as provided in the received information and update their associated PDCP, RLC, MAC, and PHY entity configurations in the manner defined by the L3 scheduler decision information.

If accepted, it may be assumed that the MAC and PHY entities of the UE and any base station(s) (regardless of their logical state) may allocate, release, and/or update resources for an applicable radio bearer based on the L3 scheduler decision information, including any PDCP, RLC, MAC, and PHY entity configuration(s) controlled by/defined in the L3 scheduler decision information.

In some embodiments, L3 scheduler decision information (including any associated PDCP, RLC, MAC, and PHY entity configurations) may be considered valid during a corresponding L3 scheduling window,.

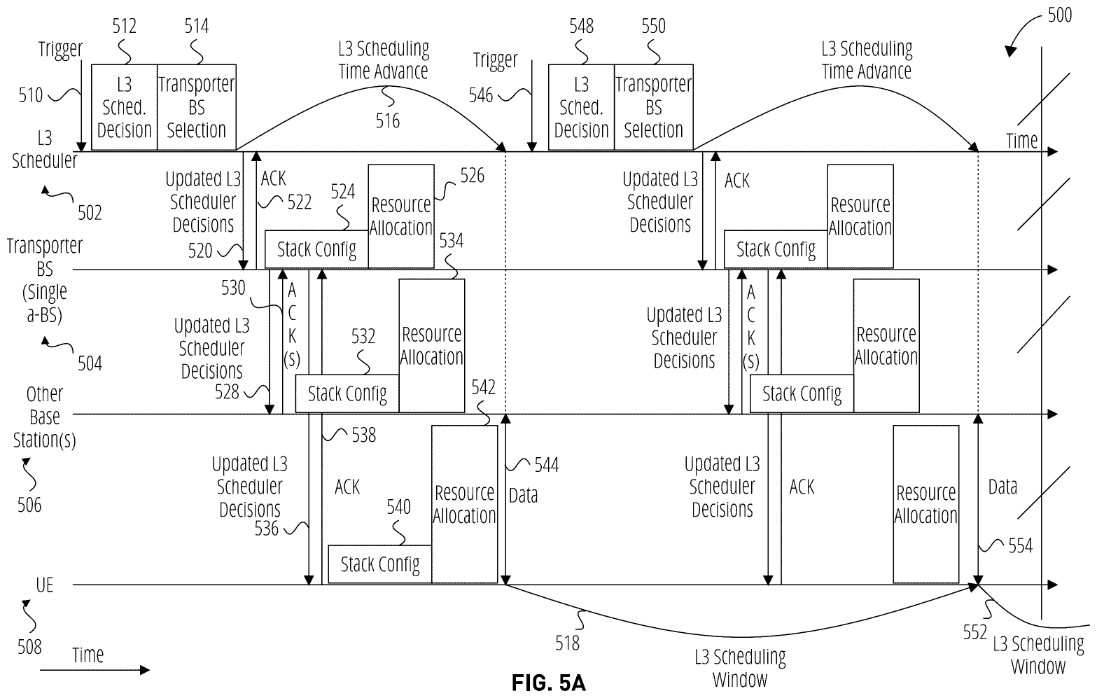

FIG. 5A and FIG. 5B together illustrate an example timeline 500 for the use of a latency-constrained L3 scheduling agreement protocol, according to embodiments discussed herein. In at least some ways, the timeline 500 may be considered a more particularized embodiment of the timeline 400 of FIG. 4 for an L3 scheduling agreement protocol that has been further adjusted to more clearly show particular aspects that may be used in cases where the L3 scheduling agreement protocol is a latency-constrained L3 scheduling agreement protocol.

The timeline 500 illustrates functionalities of and communications between an L3 scheduler 502, a transporter base station 504, one or more other base station(s) 506, and a UE 508. The transporter base station 504 and the other base station(s) 506 may be the base stations that make up the cluster for the UE 508. The L3 scheduler 502 may exist within/as part of a CCF for this cluster.

As illustrated, a first trigger 510 occurs, causing the L3 scheduler 502 to take a first L3 scheduling decision 512. The first trigger 510 may be any trigger for forming and/or updating connected sets of traffic receiving sub-cluster(s), a-BS(s), and/or i-BS(s). The first L3 scheduling decision 512 may accordingly correspond to a determined formation of and/or update to the connected sets of traffic receiving sub-cluster(s), a-BS(s), and/or i-BS(s) (and any associated PDCP, RLC, MAC, and PHY entity configurations at the transporter base station 504, the other base station(s) 506, and/or the UE 508).

As illustrated in FIG. 5A, corresponding to the first L3 scheduling decision 512, a first L3 scheduling time advance 516 is determined by the L3 scheduler 502. The L3 scheduler then identifies a corresponding first L3 scheduling window 518 (during which the first L3 scheduling decision 512 will be applied by the transporter base station 504, the other base station(s) 506, and the UE 508) having a beginning that is controlled by the end of the first L3 scheduling time advance 516, as shown.

After the first L3 scheduling decision 512 is taken, the L3 scheduler 502 then makes a first transporter base station selection 514 that identifies the one of the base stations of the cluster as the transporter base station 504.

Once the transporter base station 504 is identified, the L3 scheduler 502 sends 520 information corresponding to the first L3 scheduling decision 512 to the transporter base station 504. This information may include information about formation of and/or updates to the connected sets of traffic receiving sub-cluster(s), a-BS(s), and/or i-BS(s) (and any associated PDCP, RLC, MAC, and PHY entity configurations). This information may also include an identification of the first L3 scheduling window 518 (e.g., the beginning of the first L3 scheduling window 518) to the transporter base station 504. The transporter base station 504 may send 522 an ACK to the L3 scheduler 502 in response. As illustrated, the transporter base station 504 may also perform stack configuration 524 and resource allocation 526 according to the received information, as illustrated.

The transporter base station 504 then sends 528 the other base station(s) 506 the information corresponding to the first L3 scheduling decision 512. The other base station(s) 506 may send 530 ACK(s) to the transporter base station 504 in response. The other base station(s) 506 then perform stack configuration 532 and resource allocation 534 according to the received information, as illustrated.

The transporter base station 504 also sends 536 the UE 508 the information corresponding to the first L3 scheduling decision 512. The UE 508 may send 538 an ACK to the transporter base station 504 in response. The UE 508 then performs stack configuration 540 and resource allocation 542 according to the received information, as illustrated.

Then, once the timing of the first L3 scheduling window 518 is reached, the transporter base station 504, the other base station(s) 506, and the UE 508 perform first data communication 544 according to the first L3 scheduling decision 512.

As illustrated, during the first L3 scheduling window 518, a second trigger 546 may cause the L3 scheduler 502 to take a second L3 scheduling decision 548 (which may be different from the first L3 scheduling decision 512). The second L3 scheduling decision 548 results in information about formation of and/or updates to the connected sets of traffic receiving sub-cluster(s), a-BS(s), and/or i-BS(s) (and any associated PDCP, RLC, MAC, and PHY entity configurations) that apply to second data communication 554 and about a timing of a second L3 scheduling window 552 during which this information about the connected sets and any associated entity(s) applies.

Then, the L3 scheduler 502 takes a second transporter base station selection 550. As part of the second transporter base station selection 550 one of the base stations of the cluster is identified as the transporter base station 504. The identified base station may be the same base station as previously used to transport information of the first L3 scheduling decision 512, or it may be a different base station of the cluster.

The information of the second L3 scheduling decision 548 may then be communicated to the other base station(s) 506 and the UE 508 through the transporter base station 504 analogously to the manner previously described in relation to the information corresponding to first L3 scheduling decision 512 (as illustrated).

Note that the second trigger 546, the second L3 scheduling decision 548, and the associated communications of related information to the transporter base station 504 and further on from the transporter base station 504 to the other base station(s) 506 and the UE 508 occur while the first data communication 544 of during the first L3 scheduling window 518 is occurring.

The procedure as described may continue to repeat over time as new triggers occur, as illustrated generally across FIG. 5A and FIG. 5B.

In some embodiments corresponding to FIG. 5A and FIG. 5B, there may be no joint PHY procedures nor any base-station-to-base-station level synchronization with respect to the (single) transporter base station 504. Embodiments corresponding to FIG. 5A and FIG. 5B may (be able to) use a shorter L3 scheduling time advance and/or L3 scheduling window as compared to, e.g., cases of reliability-constrained L3 scheduling agreement protocol (the use of a latency-constrained L3 scheduling agreement protocol as illustrated in FIG. 5A and FIG. 5B may have better/lower relative latency for transporting the L3 scheduler decision information throughout the cluster).

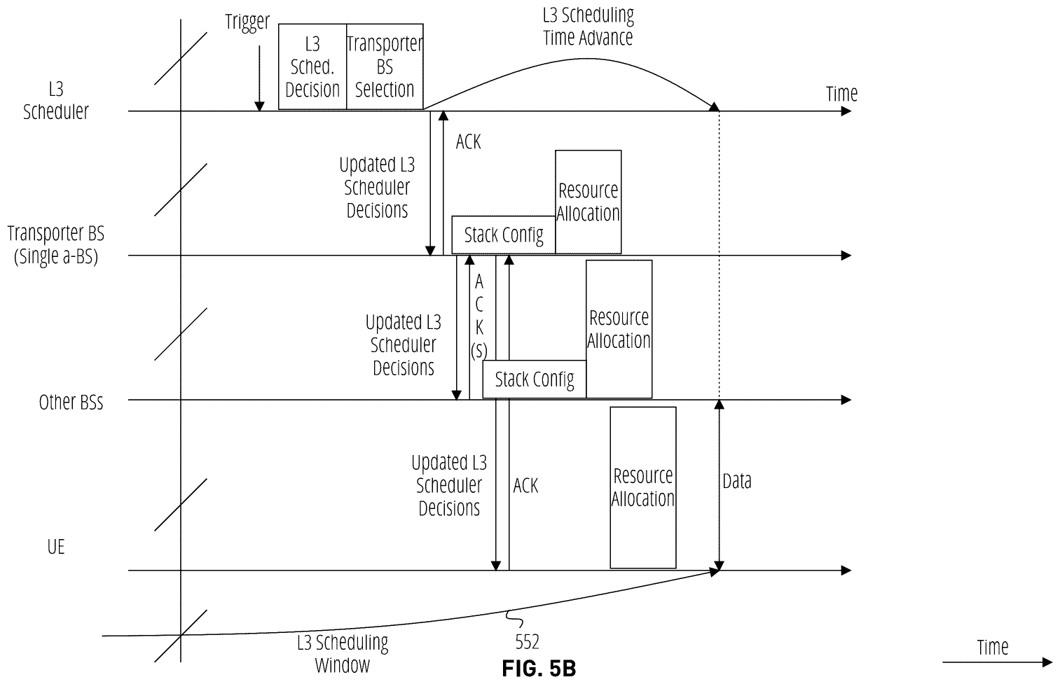

FIG. 6A and FIG. 6B together illustrate an example timeline 600 for the use of a reliability-constrained L3 scheduling agreement protocol, according to embodiments discussed herein. In at least some ways, the timeline 600 may be considered a more particularized embodiment of the timeline 400 of FIG. 4 for an L3 scheduling agreement protocol that has been further adjusted to more clearly show particular aspects that may be used in cases where the L3 scheduling agreement protocol is a reliability-constrained L3 scheduling agreement protocol.

The timeline 600 illustrates functionalities of and communications between an L3 scheduler 602, a transporter base station group 604, one or more other base station(s) 606, and a UE 608. The base stations of the transporter base station group 604 and the other base station(s) 606 may be the base stations that make up the cluster for the UE 608. The L3 scheduler 602 may exist within/as part of a CCF for this cluster.

As illustrated, a first trigger 610 occurs, causing the L3 scheduler 602 to take a first L3 scheduling decision 612. The first trigger 610 may be any trigger for forming and/or updating connected sets of traffic receiving sub-cluster(s), a-BS(s), and/or i-BS(s). The first L3 scheduling decision 612 may accordingly correspond to a determined formation of and/or update to the connected sets of traffic receiving sub-cluster(s), a-BS(s), and/or i-BS(s) (and any associated PDCP, RLC, MAC, and PHY entity configurations at the base stations of the transporter base station group 604, the other base station(s) 606, and/or the UE 608).

As illustrated in FIG. 6A, corresponding to the first L3 scheduling decision 612, a first L3 scheduling time advance 616 is determined by the L3 scheduler 602. The L3 scheduler then identifies a corresponding first L3 scheduling window 618 (during which the first L3 scheduling decision 612 will be applied by the base stations of the transporter base station group 604, the other base station(s) 606, and the UE 608) having a beginning that is controlled by the end of the first L3 scheduling time advance 616, as shown.

After the first L3 scheduling decision 612 is taken, the L3 scheduler 602 then makes a first transporter base station group selection 614 that identifies multiple base stations of the cluster as the transporter base station group 604.

Once the transporter base station group 604 is identified, the L3 scheduler 602 sends 620 information corresponding to the first L3 scheduling decision 612 to the transporter base station group 604. This information may include information about formation of and/or updates to the connected sets of traffic receiving sub-cluster(s), a-BS(s), and/or i-BS(s) (and any associated PDCP, RLC, MAC, and PHY entity configurations). This information may also include an identification of the first L3 scheduling window 618 (e.g., the beginning of the first L3 scheduling window 618) to the transporter base station group 604. The transporter base station group 604 may send 622 one or more ACK(s) to the L3 scheduler 602 in response.

The reliability-constrained L3 scheduling agreement protocol illustrated in FIG. 6A and FIG. 6B may leverage coordinated (and in at least some cases beamformed) joint transmissions as among the various ones of the base stations of the transporter base station group 604 to achieve a higher reliability in transporting the information corresponding to the first L3 scheduling decision 612 relative to, e.g., the case of the latency-constrained L3 scheduling agreement protocol (e.g., as illustrated in FIG. 5A and FIG. 5B). To achieve this level of coordination, after receiving the information about the first L3 scheduling decision 612 from the L3 scheduler 602, the base stations of the transporter base station group 604 perform synchronization 624 with each other and a coordinated beamforming 626 use may also be determined.

As illustrated, the transporter base station group 604 may also perform stack configuration 628 and resource allocation 630 according to the received information, as illustrated.

The transporter base station group 604 then sends 632 the other base station(s) 606 the information corresponding to the first L3 scheduling decision 612. The other base station(s) 606 may send 634 ACK(s) to the transporter base station group 604 in response. The other base station(s) 606 then perform stack configuration 636 and resource allocation 638 according to the received information, as illustrated.

The transporter base station group 604 also sends 640 the UE 608 the information corresponding to the first L3 scheduling decision 612. The UE 608 may send 642 an ACK to the transporter base station group 604 in response. The UE 608 then performs stack configuration 644 and resource allocation 646 according to the received information, as illustrated.

Then, once the timing of the first L3 scheduling window 618 is reached, the transporter base station group 604, the other base station(s) 606, and the UE 608 perform first data communication 648 according to the first L3 scheduling decision 612.

As illustrated, during the first L3 scheduling window 618, a second trigger 650 may cause the L3 scheduler 602 to take a second L3 scheduling decision 652 (which may be different from the first L3 scheduling decision 612). The second L3 scheduling decision 652 results in information about formation of and/or updates to the connected sets of traffic receiving sub-cluster(s), a-BS(s), and/or i-BS(s) (and any associated PDCP, RLC, MAC, and PHY entity configurations) that apply to second data communication 658 and about a timing of a second L3 scheduling window 656 during which this information about the connected sets and any associated entity(s) applies.

Then, the L3 scheduler 602 makes a second transporter base station group selection 654. As part of the second transporter base station group selection 654 multiple base stations of the cluster are identified as the transporter base station group 604. The identified base stations may be the same base stations as previously used to transport information of the first L3 scheduling decision 612, or a differing group of base stations (either in whole or in part) may instead be identified.

The transporter base station group 604 may then perform synchronization and/or beamforming determinations, and then the information of the second L3 scheduling decision 652 may be communicated to the other base station(s) 606 and the UE 608 through the transporter base station group 604 analogously to the manner previously described in relation to the information corresponding to first L3 scheduling decision 612 (as illustrated).

Note that the second trigger 650, the second L3 scheduling decision 652, the second transporter base station group selection 654 and associated synchronization and/or beamforming determinations for the transporter base station group 604, and the associated communications of information associated with the second L3 scheduling decision 652 to the transporter base station group 604 and further on from the transporter base station group 604 to the other base station(s) 606 and the UE 608 occur while the first data communication 648 is occurring.

The procedure as described may continue to repeat over time as new triggers occur, as illustrated generally across FIG. 6A and FIG. 6B.

In some embodiments corresponding to FIG. 6A and FIG. 6B, joint PHY procedures and synchronization/beamforming may be utilized for the transporter base station group 604. These synchronized/beamformed joint PHY procedures may result in increased reliability for transporting information associated with L3 scheduling decisions relative to, e.g., a latency-constrained L3 scheduling agreement protocol which does not use such procedures (as is illustrated in FIG. 5A and FIG. 5B). Embodiments corresponding to FIG. 6A and FIG. 6B may use a larger L3 scheduling time advance and/or L3 scheduling window relative to, e.g., a latency-constrained L3 scheduling agreement protocol which does not use such procedures (as is illustrated in FIG. 5A and FIG. 5B) at least in part due to additional time used for synchronization/beamforming as between the base stations of the transporter base station group 604 for purposes of supporting the joint PHY procedure.

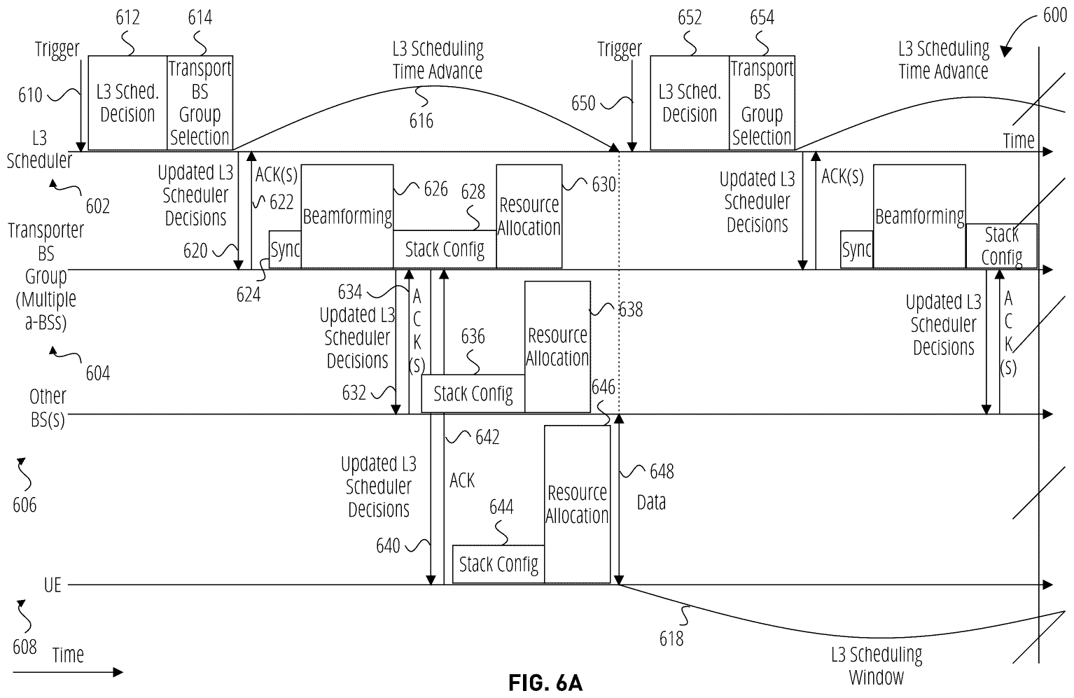

FIG. 7 illustrates a method 700 of a CCF of a wireless communication system for performing L3 scheduling for a cluster of base stations used to communicate traffic with a UE on a radio bearer and that is divided into a plurality of sub-clusters, according to embodiments discussed herein. The method 700 includes making 702 an L3 scheduling determination that identifies a traffic-receiving sub-cluster from the plurality of sub-clusters and an active base station (a-BS) in the traffic-receiving sub-cluster. The method 700 further includes sending 704, to the cluster of base stations, the L3 scheduling determination.

In some embodiments of the method 700, the L3 scheduling determination further identifies a non-traffic-receiving sub-cluster from the plurality of sub-clusters of the base stations.

In some embodiments of the method 700, the L3 scheduling determination further identifies an i-BS in the traffic-receiving sub-cluster.

In some embodiments, the method 700 further includes receiving, from the cluster of base stations, an acknowledgement of the L3 scheduling determination.

In some embodiments of the method 700, the L3 scheduling determination is triggered based on feedback from the UE.

In some embodiments of the method 700, the L3 scheduling determination is triggered based on a change to RLC synchronization used among the cluster of base stations.

In some embodiments of the method 700, the L3 scheduling determination is triggered based on receiving any of: a first request to add a base station to the traffic-receiving sub-cluster; a second request to remove a base station from the traffic receiving sub-cluster; a third request to use a base station as the a-BS; and a fourth request to use a base station as an i-BS.

In some embodiments of the method 700, the L3 scheduling determination is sent to the cluster of base stations by an L3 scheduling time advance value prior to an L3 scheduling window that is for communicating the traffic between the UE and the cluster of base stations according to the L3 scheduling determination.

In some embodiments of the method 700, the CCF sends the L3 scheduling determination to the cluster of base stations by sending the L3 scheduling determination to a transporter base station for the cluster of base stations.

In some embodiments of the method 700, the CCF sends the L3 scheduling determination to the cluster of base stations by sending the L3 scheduling determination to a transporter base station group for the cluster of base stations.

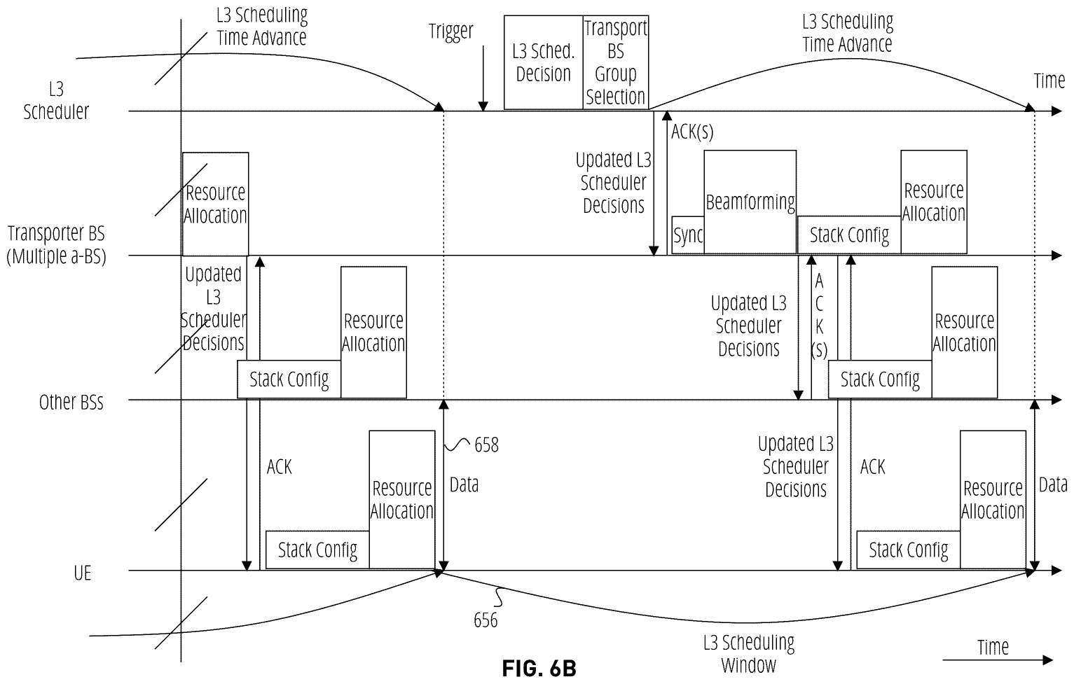

FIG. 8 illustrates a method 800 of a base station of a wireless communication system that is in a first sub-cluster of a cluster of base stations used communicate traffic with a UE on a radio bearer, according to embodiments discussed herein. The method 800 includes receiving 802, from a CCF of the wireless communication system, an L3 scheduling determination that identifies the first sub-cluster as a traffic-receiving sub-cluster and the base station as an a-BS. The method 800 further includes configuring 804 a protocol stack of the base station according to the L3 scheduling determination. The method 800 further includes routing 806 the traffic according to the protocol stack.

In some embodiments of the method 800, the L3 scheduling determination further identifies a second sub-cluster of the cluster of base stations as a non-traffic-receiving sub-cluster.

In some embodiments of the method 800, the L3 scheduling determination further identifies an i-BS in the first sub-cluster.

In some embodiments, the method 800 further includes sending, to the CCF, an acknowledgement of the L3 scheduling determination.

In some embodiments, the method 800 further includes sending, to the CCF, one or more of: a first request to add the base station to the traffic-receiving sub-cluster; a second request to remove the base station from the traffic receiving sub-cluster; a third request to use the base station as the a-BS; and a fourth request to use the base station as an i-BS.

In some embodiments of the method 800, the L3 scheduling determination is received from the CCF by an L3 scheduling time advance value prior to an L3 scheduling window that is for communicating the traffic between the UE and the cluster of base stations according to the L3 scheduling determination.

In some embodiments of the method 800, the base station is a transporter base station for the cluster of base stations, and further comprising sending, to another base station of the cluster of base stations, the L3 scheduling determination.

In some embodiments of the method 800, the base station is a member of a transporter base station group for the cluster of base stations, and further comprising sending, as part of the transporter base station group, to another base station of the cluster of base stations, the L3 scheduling determination.

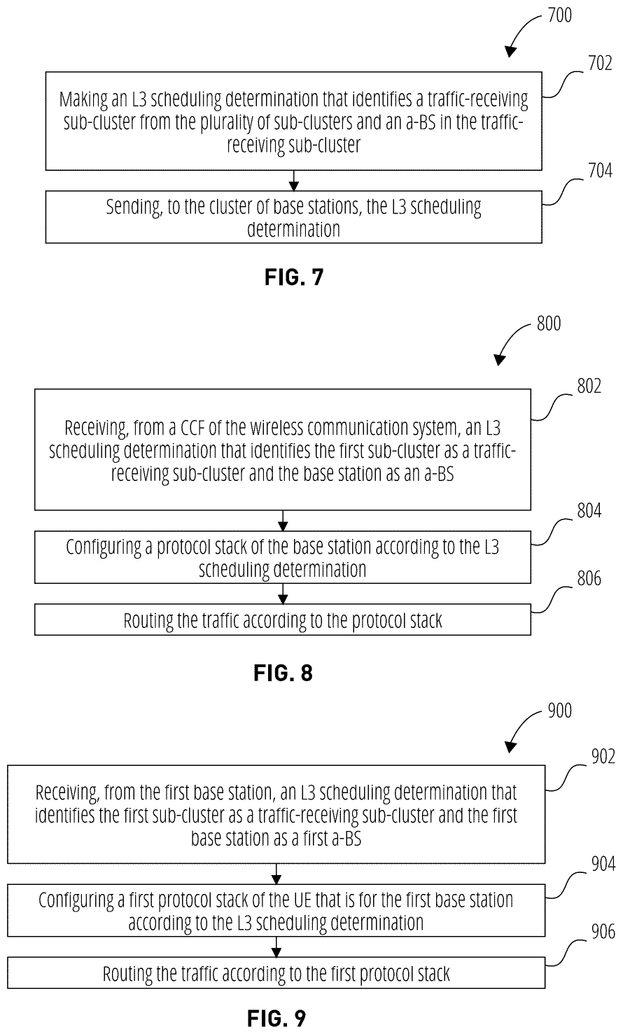

FIG. 9 illustrates a method 900 of a UE for operating with a first base station of a wireless communication system that is in a first sub-cluster of a cluster of base stations used communicate traffic with the UE on a radio bearer, according to embodiments discussed herein. The method 900 includes receiving 902, from the first base station, an L3 scheduling determination that identifies the first sub-cluster as a traffic-receiving sub-cluster and the first base station as a first a-BS. The method 900 further includes configuring 904 a first protocol stack of the UE that is for the first base station according to the L3 scheduling determination. The method 900 further includes routing 906 the traffic according to the first protocol stack.

In some embodiments, the method 900 further includes configuring a second protocol stack of the UE that is for a second base station of the cluster of base stations according to the L3 scheduling determination. In some of these embodiments, the L3 scheduling determination identifies the second base station as a second a-BS, and wherein the UE configures the second protocol stack with an active MAC entity and an active PHY entity. In some of these embodiments, the L3 scheduling determination identifies the second base station as an i-BS, and wherein the UE configures the second protocol stack with an inactive MAC entity and an inactive PHY entity.

In some embodiments of the method 900, the L3 scheduling determination further identifies a second sub-cluster of the cluster of base stations as a non-traffic-receiving sub-cluster.

In some embodiments of the method 900, the L3 scheduling determination further identifies an i-BS in the first sub-cluster.

In some embodiments, the method 900 further includes sending, to the first base station, an acknowledgement of the L3 scheduling determination.

In some embodiments, the method 900 further includes sending, to a CCF, through the first base station, one or more of: a first request to add the first base station to the traffic-receiving sub-cluster; a second request to remove first the base station from the traffic receiving sub-cluster; a third request to use the first base station as the first a-BS; and a fourth request to use the first base station as an i-BS.

In some embodiments of the method 900, the L3 scheduling determination is received from the first base station prior to an L3 scheduling window that is for communicating the traffic between the UE and the cluster of base stations according to the L3 scheduling determination.

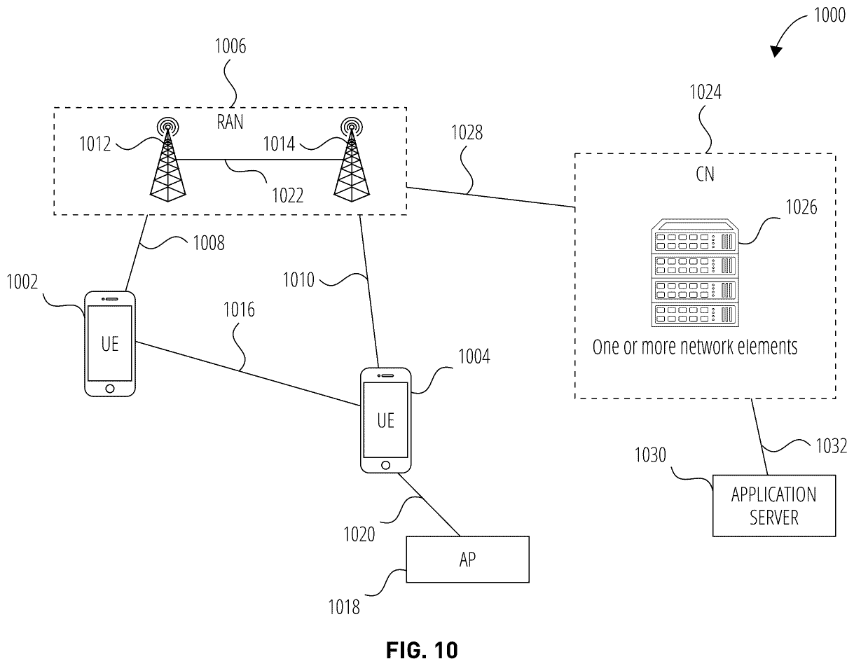

FIG. 10 illustrates an example architecture of a wireless communication system 1000, according to embodiments disclosed herein. The following description is provided for an example wireless communication system 1000 that operates in conjunction with the LTE system standards and/or 5G or NR system standards as provided by 3GPP technical specifications.

As shown by FIG. 10, the wireless communication system 1000 includes UE 1002 and UE 1004 (although any number of UEs may be used). In this example, the UE 1002 and the UE 1004 are illustrated as smartphones (e.g., handheld touchscreen mobile computing devices connectable to one or more cellular networks), but may also comprise any mobile or non-mobile computing device configured for wireless communication.

The UE 1002 and UE 1004 may be configured to communicatively couple with a RAN 1006. In embodiments, the RAN 1006 may be NG-RAN, E-UTRAN, etc. The UE 1002 and UE 1004 utilize connections (or channels) (shown as connection 1008 and connection 1010, respectively) with the RAN 1006, each of which comprises a physical communications interface. The RAN 1006 can include one or more base stations (such as base station 1012 and base station 1014) that enable the connection 1008 and connection 1010.

In this example, the connection 1008 and connection 1010 are air interfaces to enable such communicative coupling, and may be consistent with RAT(s) used by the RAN 1006, such as, for example, an LTE and/or NR.

In some embodiments, the UE 1002 and UE 1004 may also directly exchange communication data via a sidelink interface 1016. The UE 1004 is shown to be configured to access an access point (shown as AP 1018) via connection 1020. By way of example, the connection 1020 can comprise a local wireless connection, such as a connection consistent with any IEEE 802.11 protocol, wherein the AP 1018 may comprise a Wi-Fi® router. In this example, the AP 1018 may be connected to another network (for example, the Internet) without going through a CN 1024.

In embodiments, the UE 1002 and UE 1004 can be configured to communicate using orthogonal frequency division multiplexing (OFDM) communication signals with each other or with the base station 1012 and/or the base station 1014 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1012 or base station 1014 may be implemented as one or more software entities running on server computers as part of a virtual network. In addition, or in other embodiments, the base station 1012 or base station 1014 may be configured to communicate with one another via interface 1022. In embodiments where the wireless communication system 1000 is an LTE system (e.g., when the CN 1024 is an EPC), the interface 1022 may be an X2 interface. The X2 interface may be defined between two or more base stations (e.g., two or more eNBs and the like) that connect to an EPC, and/or between two eNBs connecting to the EPC. In embodiments where the wireless communication system 1000 is an NR system (e.g., when CN 1024 is a 5GC), the interface 1022 may be an Xn interface. The Xn interface is defined between two or more base stations (e.g., two or more gNBs and the like) that connect to 5GC, between a base station 1012 (e.g., a gNB) connecting to 5GC and an eNB, and/or between two eNBs connecting to 5GC (e.g., CN 1024).

The RAN 1006 is shown to be communicatively coupled to the CN 1024. The CN 1024 may comprise one or more network elements 1026, which are configured to offer various data and telecommunications services to customers/subscribers (e.g., users of UE 1002 and UE 1004) who are connected to the CN 1024 via the RAN 1006. The components of the CN 1024 may be implemented in one physical device or separate physical devices including components to read and execute instructions from a machine-readable or computer-readable medium (e.g., a non-transitory machine-readable storage medium).

In embodiments, the CN 1024 may be an EPC, and the RAN 1006 may be connected with the CN 1024 via an S1 interface 1028. In embodiments, the S1 interface 1028 may be split into two parts, an S1 user plane (S1-U) interface, which carries traffic data between the base station 1012 or base station 1014 and a serving gateway (S-GW), and the S1-MME interface, which is a signaling interface between the base station 1012 or base station 1014 and mobility management entities (MMEs).

In embodiments, the CN 1024 may be a 5GC, and the RAN 1006 may be connected with the CN 1024 via an NG interface 1028. In embodiments, the NG interface 1028 may be split into two parts, an NG user plane (NG-U) interface, which carries traffic data between the base station 1012 or base station 1014 and a user plane function (UPF), and the S1 control plane (NG-C) interface, which is a signaling interface between the base station 1012 or base station 1014 and access and mobility management functions (AMFs).

Generally, an application server 1030 may be an element offering applications that use internet protocol (IP) bearer resources with the CN 1024 (e.g., packet switched data services). The application server 1030 can also be configured to support one or more communication services (e.g., VOIP sessions, group communication sessions, etc.) for the UE 1002 and UE 1004 via the CN 1024. The application server 1030 may communicate with the CN 1024 through an IP communications interface 1032.

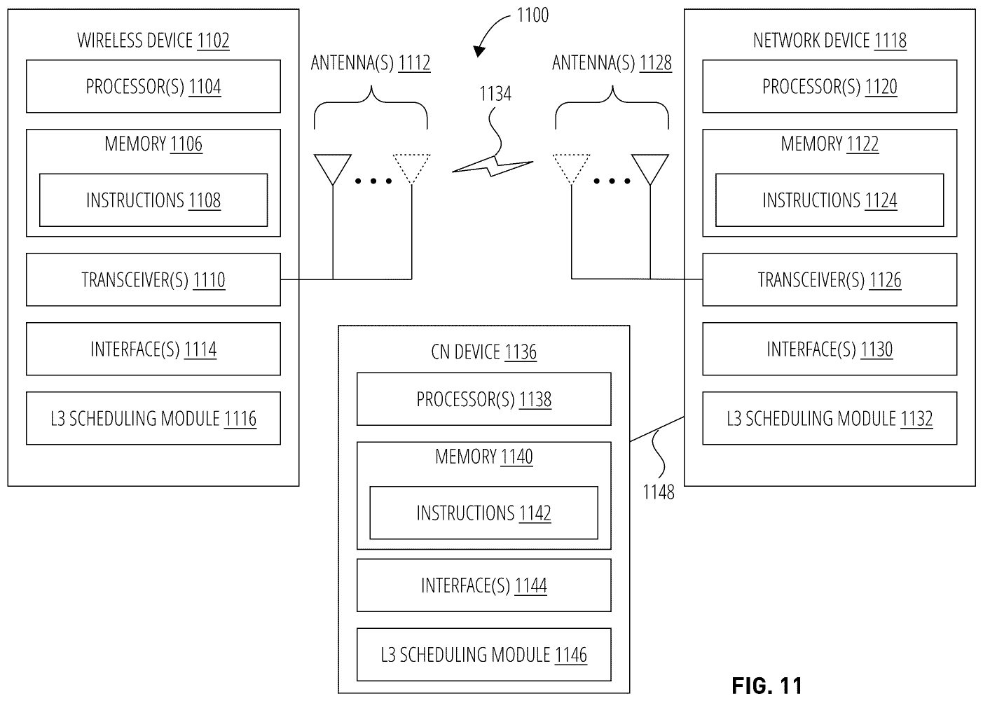

FIG. 11 illustrates a system 1100 for performing signaling 1134 between a wireless device 1102 and a network device 1118 as supported by a CN device 1136, according to embodiments disclosed herein. The system 1100 may be a portion of a wireless communications system as herein described. The wireless device 1102 may be, for example, a UE of a wireless communication system. The network device 1118 may be, for example, a base station (e.g., an eNB, a gNB, or a sixth generation base station) of a wireless communication system.

The wireless device 1102 may include one or more processor(s) 1104. The processor(s) 1104 may execute instructions such that various operations of the wireless device 1102 are performed, as described herein. The processor(s) 1104 may include one or more baseband processors implemented using, for example, a CPU, a digital signal processor (DSP), an application specific integrated circuit (ASIC), a controller, a field programmable gate array (FPGA) device, another hardware device, a firmware device, or any combination thereof configured to perform the operations described herein.

The wireless device 1102 may include a memory 1106. The memory 1106 may be a non-transitory computer-readable storage medium that stores instructions 1108 (which may include, for example, the instructions being executed by the processor(s) 1104). The instructions 1108 may also be referred to as program code or a computer program. The memory 1106 may also store data used by, and results computed by, the processor(s) 1104.

The wireless device 1102 may include one or more transceiver(s) 1110 that may include radio frequency (RF) transmitter circuitry and/or receiver circuitry that use the antenna(s) 1112 of the wireless device 1102 to facilitate signaling (e.g., the signaling 1134) to and/or from the wireless device 1102 with other devices (e.g., the network device 1118) according to corresponding RATs.

The wireless device 1102 may include one or more antenna(s) 1112 (e.g., one, two, four, or more). For embodiments with multiple antenna(s) 1112, the wireless device 1102 may leverage the spatial diversity of such multiple antenna(s) 1112 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1102 may be accomplished according to precoding (or digital beamforming) that is applied at the wireless device 1102 that multiplexes the data streams across the antenna(s) 1112 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1102 may implement analog beamforming techniques, whereby phases of the signals sent by the antenna(s) 1112 are relatively adjusted such that the (joint) transmission of the antenna(s) 1112 can be directed (this is sometimes referred to as beam steering).

The wireless device 1102 may include one or more interface(s) 1114. The interface(s) 1114 may be used to provide input to or output from the wireless device 1102. For example, a wireless device 1102 that is a UE may include interface(s) 1114 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1110/antenna(s) 1112 already described) that allow for communication between the UE and other devices and may operate according to known protocols (e.g., Wi-Fi®, Bluetooth®, and the like).

The wireless device 1102 may include an L3 scheduling module 1116. The L3 scheduling module 1116 may be implemented via hardware, software, or combinations thereof. For example, the L3 scheduling module 1116 may be implemented as a processor, circuit, and/or instructions 1108 stored in the memory 1106 and executed by the processor(s) 1104. In some examples, the L3 scheduling module 1116 may be integrated within the processor(s) 1104 and/or the transceiver(s) 1110. For example, the L3 scheduling module 1116 may be implemented by a combination of software components (e.g., executed by a DSP or a general processor) and hardware components (e.g., logic gates and circuitry) within the processor(s) 1104 or the transceiver(s) 1110.

The L3 scheduling module 1116 may be used for various aspects of the present disclosure, for example, aspects of FIG. 9. For example, the L3 scheduling module 1116 may configure the wireless device 1102 to receive and use information corresponding to L3 scheduling determinations of an L3 scheduler (e.g., a CCF), as described herein.

The network device 1118 may include one or more processor(s) 1120. The processor(s) 1120 may execute instructions such that various operations of the network device 1118 are performed, as described herein. The processor(s) 1120 may include one or more baseband processors implemented using, for example, a CPU, a DSP, an ASIC, a controller, an FPGA device, another hardware device, a firmware device, or any combination thereof configured to perform the operations described herein.

The network device 1118 may include a memory 1122. The memory 1122 may be a non-transitory computer-readable storage medium that stores instructions 1124 (which may include, for example, the instructions being executed by the processor(s) 1120). The instructions 1124 may also be referred to as program code or a computer program. The memory 1122 may also store data used by, and results computed by, the processor(s) 1120.

The network device 1118 may include one or more transceiver(s) 1126 that may include RF transmitter circuitry and/or receiver circuitry that use the antenna(s) 1128 of the network device 1118 to facilitate signaling (e.g., the signaling 1134) to and/or from the network device 1118 with other devices (e.g., the wireless device 1102) according to corresponding RATs.

The network device 1118 may include one or more antenna(s) 1128 (e.g., one, two, four, or more). In embodiments having multiple antenna(s) 1128, the network device 1118 may perform MIMO, digital beamforming, analog beamforming, beam steering, etc., as has been described.

The network device 1118 may include one or more interface(s) 1130. The interface(s) 1130 may be used to provide input to or output from the network device 1118. For example, a network device 1118 that is a base station may include interface(s) 1130 made up of transmitters, receivers, and other circuitry (e.g., other than the transceiver(s) 1126/antenna(s) 1128 already described) that enables the base station to communicate with other equipment in a core network, and/or that enables the base station to communicate with external networks, computers, databases, and the like for purposes of operations, administration, and maintenance of the base station or other equipment operably connected thereto. As another example, the network device 1118 may communicate with the CN device 1136 on an interface 1148 of the interface(s) 1130 (which, in, for example, NR cases, may be an NG interface or in LTE cases may be an S1 interface).

The network device 1118 may include an L3 scheduling module 1132. The L3 scheduling module 1132 may be implemented via hardware, software, or combinations thereof. For example, the L3 scheduling module 1132 may be implemented as a processor, circuit, and/or instructions 1124stored in the memory 1122 and executed by the processor(s) 1120. In some examples, the L3 scheduling module 1132 may be integrated within the processor(s) 1120 and/or the transceiver(s) 1126. For example, the L3 scheduling module 1132 may be implemented by a combination of software components (e.g., executed by a DSP or a general processor) and hardware components (e.g., logic gates and circuitry) within the processor(s) 1120 or the transceiver(s) 1126.

The L3 scheduling module 1132 may be used for various aspects of the present disclosure, for example, aspects of FIG. 7 and/or FIG. 8. For example, the L3 scheduling module 1132 may configure the network device 1118 to generate, send, receive, and/or use information corresponding to L3 scheduling determinations of an L3 scheduler (e.g., a CCF), as described herein.

The CN device 1136 may include one or more processor(s) 1138. The processor(s) 1138 may execute instructions such that various operations of the CN device 1136 are performed, as described herein. The processor(s) 1138 may include one or more baseband processors implemented using, for example, a CPU, a DSP, an ASIC, a controller, an FPGA device, another hardware device, a firmware device, or any combination thereof configured to perform the operations described herein.

The CN device 1136 may include a memory 1140. The memory 1140 may be a non-transitory computer-readable storage medium that stores instructions 1142 (which may include, for example, the instructions being executed by the processor(s) 1138). The instructions 1142 may also be referred to as program code or a computer program. The memory 1140 may also store data used by, and results computed by, the processor(s) 1138.

The CN device 1136 may include one or more interface(s) 1144. The interface(s) 1144 may be used to provide input to or output from the CN device 1136. For example, a CN device 1136 may communicate with the network device 1118 on an interface 1148 of the interface(s) 1144 (which, in, for example, NR cases, may be an NG interface or in LTE cases may be an S1 interface).

The CN device 1136 may include an L3 scheduling module 1146. The L3 scheduling module 1146 may be implemented via hardware, software, or combinations thereof. For example, the L3 scheduling module 1146 may be implemented as a processor, circuit, and/or instructions 1142 stored in the memory 1140 and executed by the processor(s) 1138. In some examples, the L3 scheduling module 1146 may be integrated within the processor(s) 1138. For example, the L3 scheduling module 1146 may be implemented by a combination of software components (e.g., executed by a DSP or a general processor) and hardware components (e.g., logic gates and circuitry) within the processor(s) 1138.

The L3 scheduling module 1146 may be used for various aspects of the present disclosure, for example, aspects of FIG. 7. For example, the L3 scheduling module 1146 may configure the CN device 1136 to generate and send information corresponding to L3 scheduling determinations of an L3 scheduler (e.g., a CCF), as described herein.

Embodiments contemplated herein include an apparatus comprising means to perform one or more elements of the method 900. This apparatus may be, for example, an apparatus of a UE (such as a wireless device 1102 that is a UE, as described herein).

Embodiments contemplated herein include one or more non-transitory computer-readable media comprising instructions to cause an electronic device, upon execution of the instructions by one or more processors of the electronic device, to perform one or more elements of the method 900. This non-transitory computer-readable media may be, for example, a memory of a UE (such as a memory 1106 of a wireless device 1102 that is a UE, as described herein).

Embodiments contemplated herein include an apparatus comprising logic, modules, or circuitry to perform one or more elements of the method 900. This apparatus may be, for example, an apparatus of a UE (such as a wireless device 1102 that is a UE, as described herein).

Embodiments contemplated herein include an apparatus comprising: one or more processors and one or more computer-readable media comprising instructions that, when executed by the one or more processors, cause the one or more processors to perform one or more elements of the method 900. This apparatus may be, for example, an apparatus of a UE (such as a wireless device 1102 that is a UE, as described herein).

Embodiments contemplated herein include a signal as described in or related to one or more elements of the method 900.

Embodiments contemplated herein include a computer program or computer program product comprising instructions, wherein execution of the program by a processor is to cause the processor to carry out one or more elements of the method 900. The processor may be a processor of a UE (such as a processor(s) 1104 of a wireless device 1102 that is a UE, as described herein). These instructions may be, for example, located in the processor and/or on a memory of the UE (such as a memory 1106 of a wireless device 1102 that is a UE, as described herein).

Embodiments contemplated herein include an apparatus comprising means to perform one or more elements of the method 800. This apparatus may be, for example, an apparatus of a base station (such as a network device 1118 that is a base station, as described herein).

Embodiments contemplated herein include one or more non-transitory computer-readable media comprising instructions to cause an electronic device, upon execution of the instructions by one or more processors of the electronic device, to perform one or more elements of the method 800. This non-transitory computer-readable media may be, for example, a memory of a base station (such as a memory 1122 of a network device 1118 that is a base station, as described herein).

Embodiments contemplated herein include an apparatus comprising logic, modules, or circuitry to perform one or more elements of the method 800. This apparatus may be, for example, an apparatus of a base station (such as a network device 1118 that is a base station, as described herein).

Embodiments contemplated herein include an apparatus comprising: one or more processors and one or more computer-readable media comprising instructions that, when executed by the one or more processors, cause the one or more processors to perform one or more elements of the method 800. This apparatus may be, for example, an apparatus of a base station (such as a network device 1118 that is a base station, as described herein).

Embodiments contemplated herein include a signal as described in or related to one or more elements of the method 800.

Embodiments contemplated herein include a computer program or computer program product comprising instructions, wherein execution of the program by a processing element is to cause the processing element to carry out one or more elements of the method 800. The processor may be a processor of a base station (such as a processor(s) 1120 of a network device 1118 that is a base station, as described herein). These instructions may be, for example, located in the processor and/or on a memory of the base station (such as a memory 1122 of a network device 1118 that is a base station, as described herein).

Embodiments contemplated herein include an apparatus comprising means to perform one or more elements of the method 700. This apparatus may be, for example, an apparatus of a base station (such as a network device 1118 that is a base station, as described herein) and/or of a CN (such as the CN device 1136, as described herein). It is further contemplated that this apparatus may be one of many such apparatuses working together in a distributed fashion to perform the one or more elements of the method 700.

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of a base station (such as a memory 1140 of a network device 1118 that is a base station, as described herein) and/or of a CN (such as the memory 1140 of a CN device 1136, as described herein). It is further contemplated that the electronic device may be one of many such electronic devices working together in a distributed fashion to perform the one or more elements of the method 700.

Embodiments contemplated herein include an apparatus comprising logic, modules, or circuitry to perform one or more elements of the method 700. This apparatus may be, for example, an apparatus of a base station (such as a network device 1118 that is a base station, as described herein) and/or of a CN (such as the CN device 1136, as described herein). It is further contemplated that this apparatus may be one of many such apparatuses working together in a distributed fashion to perform the one or more elements of the method 700.

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of a base station (such as a network device 1118 that is a base station, as described herein) and/or of a CN (such as the CN device 1136, as described herein). It is further contemplated that this apparatus may be one of many such apparatuses working together in a distributed fashion to perform the one or more elements of the method 700.

Embodiments contemplated herein include a signal as described in or related to one or more elements of the method 700.

Embodiments contemplated herein include a computer program or computer program product comprising instructions, wherein execution of the program by a processing element is to cause the processing element to carry out one or more elements of the method 700. The processor may be a processor of a base station (such as a processor(s) 1120 of a network device 1118 that is a base station, as described herein). These instructions may be, for example, located in the processor and/or on a memory of the base station (such as a memory 1122 of a network device 1118 that is a base station, as described herein). The processor may be a processor of a CN device (such as a processor(s) 1138 of a CN device 1136, as described herein). These instructions may be, for example, located in the processor and/or on a memory of the CN device (such as a memory 1140 of a CN device 1136, as described herein). It is further contemplated that the processing element may be one of many such processing elements working together in a distributed fashion to perform the one or more elements of the method 700.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a clustering control function (CCF) of a wireless communication system for performing layer 3 (L3) scheduling for a cluster of base stations used to communicate traffic with a user equipment (UE) on a radio bearer and that is divided into a plurality of sub-clusters, comprising:
making an L3 scheduling determination that identifies a traffic-receiving sub-cluster from the plurality of sub-clusters and an active base station (a-BS) in the traffic-receiving sub-cluster; and
sending, to the cluster of base stations, the L3 scheduling determination.

2. The method of claim 1, wherein the L3 scheduling determination is triggered based on feedback from the UE.

3. The method of claim 1, wherein the L3 scheduling determination is triggered based on a change to radio link control (RLC) synchronization used among the cluster of base stations.

4. The method of claim 1, wherein the L3 scheduling determination is triggered based on receiving any of:
a first request to add a base station to the traffic-receiving sub-cluster;
a second request to remove a base station from the traffic receiving sub-cluster;
a third request to use a base station as the a-BS; and
a fourth request to use a base station as an inactive base station (i-BS).

5. The method of claim 1, wherein the L3 scheduling determination is sent to the cluster of base stations by an L3 scheduling time advance value prior to an L3 scheduling window that is for communicating the traffic between the UE and the cluster of base stations according to the L3 scheduling determination.

6. The method of claim 1, wherein the CCF sends the L3 scheduling determination to the cluster of base stations by sending the L3 scheduling determination to a transporter base station for the cluster of base stations.

7. The method of claim 1, wherein the CCF sends the L3 scheduling determination to the cluster of base stations by sending the L3 scheduling determination to a transporter base station group for the cluster of base stations.

8. A method of a base station of a wireless communication system that is in a first sub-cluster of a cluster of base stations used communicate traffic with a user equipment (UE) on a radio bearer, comprising:
receiving, from a clustering control function (CCF) of the wireless communication system, an L3 scheduling determination that identifies the first sub-cluster as a traffic-receiving sub-cluster and the base station as an active base station (a-BS);
configuring a protocol stack of the base station according to the L3 scheduling determination; and
routing the traffic according to the protocol stack.

9. The method of claim 8, wherein the L3 scheduling determination further identifies a second sub-cluster of the cluster of base stations as a non-traffic-receiving sub-cluster.

10. The method of claim 8, wherein the L3 scheduling determination further identifies an inactive base station (i-BS) in the first sub-cluster.

11. The method of claim 8, wherein the base station is a transporter base station for the cluster of base stations, and further comprising sending, to another base station of the cluster of base stations, the L3 scheduling determination.

12. The method of claim 8, wherein the base station is a member of a transporter base station group for the cluster of base stations, and further comprising sending, as part of the transporter base station group, to another base station of the cluster of base stations, the L3 scheduling determination.

13. A method of a user equipment (UE) for operating with a first base station of a wireless communication system that is in a first sub-cluster of a cluster of base stations used communicate traffic with the UE on a radio bearer, comprising:
receiving, from the first base station, an L3 scheduling determination that identifies the first sub-cluster as a traffic-receiving sub-cluster and the first base station as a first active base station (a-BS);
configuring a first protocol stack of the UE that is for the first base station according to the L3 scheduling determination; and
routing the traffic according to the first protocol stack.

14. The method of claim 13, further comprising configuring a second protocol stack of the UE that is for a second base station of the cluster of base stations according to the L3 scheduling determination.

15. The method of claim 14, wherein the L3 scheduling determination identifies the second base station as a second a-BS, and wherein the UE configures the second protocol stack with an active medium access control (MAC) entity and an active physical (PHY) layer entity.

16. The method of claim 14, wherein the L3 scheduling determination identifies the second base station as an inactive base station (i-BS), and wherein the UE configures the second protocol stack with an inactive medium access control (MAC) entity and an inactive physical (PHY) layer entity.

17. The method of claim 13, wherein the L3 scheduling determination further identifies a second sub-cluster of the cluster of base stations as a non-traffic-receiving sub-cluster.

18. The method of claim 13, wherein the L3 scheduling determination further identifies an inactive base station (i-BS) in the first sub-cluster.

19. The method of claim 13, further comprising sending, to a clustering control function (CCF), through the first base station, one or more of:
a first request to add the first base station to the traffic-receiving sub-cluster;
a second request to remove first the base station from the traffic receiving sub-cluster;
a third request to use the first base station as the first a-BS; and
a fourth request to use the first base station as an inactive base station (i-BS).

20. The method of claim 13, wherein the L3 scheduling determination is received from the first base station prior to an L3 scheduling window that is for communicating the traffic between the UE and the cluster of base stations according to the L3 scheduling determination.
